(19) United States
(12) Patent Application Publication
(10) Pub. No.: US 2016/0115968 A1
(43) Pub. Date: Apr. 28, 2016

(54) BLADELESS FLUID PROPULSION PUMP

(71) Applicant: Ralf W. Blackstone, Clearwater, FL (US)

(72) Inventor: Ralf W. Blackstone, Clearwater, FL (US)

(21) Appl. No.: 14/924,110

(22) Filed: Oct. 27, 2015

Related U.S. Application Data
(60) Provisional application No. 62/068,981, filed on Oct. 27, 2014.

(51) Int. Cl. F04D 29/28; F04D 17/12; F04D 29/66; B29C 45/00; F04D 29/62; B21D 22/02; B21D 53/26; F04D 1/06; F04D 29/42

(52) U.S. Cl. CPC F04D 29/288; F04D 1/06; F04D 17/12; F04D 29/669; F04D 29/668; F04D 29/426; F04D 29/4206; F04D 29/624; F04D 29/628; B21D 22/02; B21D 53/26; B29C 45/00; B29D 99/0025

(57) ABSTRACT

A method of manufacturing a rotor assembly for a bladeless pump is provided, the method comprising providing an injection mold or stamping having a reference mark; injection molding or stamping multiple rotors from the mold or stamp, the rotors having a reference mark thereon and spokes; and assembling the rotors on an axle such that any balances eccentricities are minimized. A pump is provided having a rotor assembly having multiple rotors, each rotor with an outer periphery and an axle; a rotor assembly housing; a spiral volute having a knife edge wherein the rotor assembly is mounted close to the knife edge.

This application claims the benefit of, priority to, and incorporates by reference U.S. Provisional Patent Application Ser. No. 62/068,981, filed Oct. 27, 2014; U.S. patent application Ser. No. 14/310,554, filed Jun. 20, 2014; U.S. patent application Ser. No. 12/599,776, filed Nov. 11, 2009; and U.S. Provisional Application Ser. No. 60/930,472, filed May 16, 2007.

### FIELD OF THE INVENTION

A fluid propulsion pump, more specifically, a bladeless fluid propulsion pump.

### BACKGROUND

Most pumps use blades to impart energy to molecules of a fluid, such as a gas or liquid. However, some pumps are directed to the application of mechanical power to a fluid without the use of blades. One such bladeless pump is disclosed in U.S. Pat. No. 1,061,142 (Tesla 1913, incorporated herein by reference, see FIGS. 1a and 1b). Tesla discloses the use of a series of parallel motor driven, closely spaced, rotors or discs, the spinning of which causes a fluid introduced near the center to be propelled outward across a surface of a disc through the adhesion of the fluid at the surface of the disc. Such a device will generally be hereinafter referred to as a bladeless pump.

### OBJECTS OF THE INVENTION

It is the object of this invention to provide a high efficiency, bladeless pump capable of high r.p.m. and capable of high fluid volumes and pressures. This pump is also capable of propelling particulate-laden fluids without damage to the pump.

### SUMMARY OF THE INVENTION

A bladeless fluid pump having a variety of unique features, alone or in combination, which provide an improvement over prior art bladeless pumps, especially at high r.p.m.

Applicant's bladeless pump comprises a rotary housing, including walls defining a volute having a knife edge, a volute fluid outlet, and walls defining a rotor feed opening. The rotor assembly includes a multiplicity of rotors, each having a runner portion, the runner portion having a first thickness T1. A multiplicity of spokes are included as part of the rotors, the spokes including walls defining an axle opening. The spokes have a thickness T2 that is greater than the thickness of the runner disc portion T1. A pair of endplates, an axle, and a retaining collar may further be included in Applicant's bladeless pump, in a preferred embodiment.

An alternate preferred embodiment provides the spokes with alignment locking means and the rotor assembly may include a pair of endplates that may be dimensioned different, for example, thicker, than the rotors or the multiplicity of rotors.

The alignment locking means may include projecting pins in the receiving indentations. These projecting pins may all have the same shape or may have different shapes, with the corresponding indentation shaped to receive the specific pin. The rotors may also include standoffs, either dimpled or non-dimpled, including a multiplicity of sets of standoffs for exact spacing between the runner portions at speed.

The axle may have a polygonal shape with faceted, broached or radius corners. On the other hand, the axle may be round and have a keyway corresponding to a keyway in the axle opening, a key for engaging the keyway of the axle and the keyway of the axle opening so rotors and/or endplates are engaged with the axle to rotate therewith.

The axle may be fused with the rotors as by using an adhesive, such as glue, to both glue the rotors together and to the axle or as by, for example, welding. When so fused, collars do not have to (but may) be used as the rotor assembly will not migrate axially when fused.

The rotors may be made of plastic, ceramic, or metal and made by injection molding, stamping, or similar manufacturing process. The end-plates may be plain or conical shaped, flat (planar) or other suitable shape. The endplates may also be connected to a locking retainer collar and may or may not have fan shaped struts. The locking retainer collar would maintain the rotor assembly in the compression. The walls defining the rotor feed opening may be radiused or without a radiused edge.

Passageway walls carry a fluid, such as a gaseous fluid, from a fluid inlet to a rotor feed opening, and these walls may be curved to accelerate the air as it moves from the fluid inlet to the rotor feed opening.

A motor may be provided to drive the rotor assembly, the motor may include bearings to align the axle with the rotor housing and the rotor assembly. The bearings may be plane bearings, ball bearings, air bearings and the like. The bearings may or may not be spaced apart from the rotor feed openings and may take a variety of configurations, including vortex or straight. Transition bearings may also be provided.

A cover and a base may be provided; the base for engagement with the rotor housing and the motor and bearing standards. Bearing standards and motor standards may be provided to support the axle and motor and to precisely position the rotor stack against the knife edge in the rotor's spiral volute housing.

There may be means, including a tube or channel for carrying high pressure air from the rotor housing to the motor and/or bearings to help cool the same. Likewise, the housing may be sealed tightly with rubber ridges for a fluid tight seal, but there may be provided openings wherein a high pressure gas cooling the motor may exit the housing away from or opposite the motor. Bearing standards and motor standards may be provided to support the axle and motor.

A method of manufacturing a rotor assembly for a bladeless pump is provided, the method comprising providing an injection mold or stamping having a reference mark; injection molding or stamping multiple rotors from the mold or stamp, the rotors having a reference mark thereon and spokes; and assembling the rotors on an axle such that any balances eccentricities are minimized. The assembling step may comprise rotating and entraining successive rotors with the reference marks on opposite sides of the axle and such that the spokes are aligned. The rotors may have standoffs defining standoff radii and, during assembling, they may be placed one with respect to an adjacent one so as to keep spokes aligned. The placing aligns the standoff radii. The placing may space angularly the standoff radii. The mold or stamping, in one embodiment, is adapted to produce rotors with perforations. During the assembling step, one may align the perforations. The step of introducing a rotor fusing agent through the aligned perforations is provided. The mold may create rotors with dimples and, during the assembling step, the rotors with the dimples are placed on the axle such that no adjacent rotors have their dimples in an aligned position and the spokes of all the rotors are aligned. The mold may create a rotor with solid stand-offs and, during assembling, the rotors may be entrained on the axle such that the stand-offs are radially aligned and wherein the spokes are aligned.

The method may further include following the assembling step: fusing the rotors to one another, wherein the reference marks are used in the assembling step to determine rotor location on an axle with respect to adjacent rotors, and wherein the mold or stamping provides for a rotor with multiplicity of concentric standoffs and the standoffs lay in equiangular standoff radii. The rotors may have standoffs and the standoffs may be spaced on equiangular spaced radii during the assembling step with spokes aligned. The spokes may include pins and indentations.

A pump is provided having a rotor assembly having multiple rotors, each rotor with an outer periphery and an axle; a rotor assembly housing; a spiral volute having a knife edge wherein the rotor assembly is mounted close to the knife edge. The pump further includes bearing standards, supporting a multiplicity of bearings and may also include a vibration isolator. The rotors may be thicker near the outer periphery. The rotors have runner portions which have standoffs, the standoffs may be fused. The rotors typically comprise an integral, one-piece spoke assembly/runners portion with the runner portion being thinner than the spoke assembly. The axle of the rotor assembly may be polygonal, and the rotors fused to the axle. The rotor assembly may be pre-balanced. The rotors may include a reference mark, and wherein the reference mark of adjacent rotors on the rotor assembly are angularly spaced apart, and wherein the rotors include a spoke section and wherein the spokes are aligned.

### BRIEF DESCRIPTION OF THE DRAWINGS

FIG. 1 shows a rotor being comprised of a runner portion and spokes, which may act as a spacer.

FIGS. 1a and 1b illustrate a prior art bladeless pump as disclosed by the Tesla patent.

FIGS. 2a, 2b, and 2c are illustrations of embodiments in perspective and elevational views of Applicant's invention.

FIG. 3 is a cross-sectional perspective view through the rotor's spiral volute housing and stack assembly of Applicant's present invention showing the base air inlet spiral volute, and the noncontact, but close placement, of the rotor assembly with the ‘knife-edge’ of the spiral volute.

FIG. 4 is a perspective view of the rotor housing showing the air or fluid inlet which may be on either or both sides of the rotor housing and fluid outlet in the base of the rotor housing.

FIG. 5 illustrates a rotor including the runner portion and the spokes and the thickness relationships between the two.

FIG. 5a illustrates in perspective view the manner in which rotos and spacers may be produced as separate elements and engaged on the shaft.

FIG. 6a illustrates Applicant's rotor assembly axle and stack assembly (rotors with endplates), as well as the manner in which endplates with retaining collars, including locking set screws and a non-round axle shaft may be used.

FIG. 6b illustrates Applicant's stack assembly, including a novel retention collar having fan-like struts connecting the collar to the endplate, the endplate illustrated being lano-conical shaped and the fan-like struts oriented to assist forward fluid flow through the rotor assembly.

FIG. 6c is a cross-sectional view of the rotor assembly showing inner walls of the rotor housing in the manner in which the conical endplates may engage bearing and glide surfaces.

FIG. 7 illustrates the manner in which pin receivers and pin projections may be used to align and, in a locking manner, engage spacers or rotors without spacers.

FIG. 8 is a perspective view of a rotor showing standoff projections, here two sets defining generally concentric circles and how the standoffs have a height that is equal to the thickness difference between the spokes and the discs.

FIG. 9 illustrates in perspective view the use of non-round axles for the purpose of engaging the rotors without the necessity of other fixing agents, including a square axle, a triangular axle, and a pentagonal axle, with their corners radiused to prevent fracturing of the rotors.

FIG. 10a illustrates the use of round shaft with dual keyways for engaging the axle to the rotors and the endplates.

FIG. 10b illustrates a dual broached axle for engaging rotors.

FIGS. 11a, 11b, 11c, and 11d illustrate four bearing outrigger supports/fixations variations where no bearing standard is required and the bearing support is fused directly to the rotor's spiral volute housing, including planar, straight, vane and vortex vane bearing support variations.

FIGS. 12a and 12b illustrate in cross-section the manner in which air bearings may be used in conjunction with transition bearings to maintain the axle in proper alignment. FIG. 12a also indicates with arrows air flow from the volute to the air bearings. FIG. 12b also illustrates the manner in which air flow may be provided to the air bearings and also to the motor to cool the motor's rotor and stator.

FIG. 13 illustrates in cross-sectional elevational view the manner in which the cover and base engage the bearing standards, turbine rotor housing, and the motor standards to hermetically seal them to the cover and thereby reinforce them and dampen vibration while the turbine is running. FIG. 13 also illustrates with arrows an assembly by which air can be directed under pressure from the turbine rotor through or past the motor and exhausted from a vent in the cover, such air flow designed to help cool the motor.

FIG. 14 illustrates an elevational cutaway view of the manner in which the cover may be sealed to elements, including bearing and motor standards, rotor housing, and the base through the use of internal cover ridges.

FIG. 15 illustrates an exploded perspective view of the manner in which air flow may be directed from the rotor assembly, under pressure, to the motor to help cool the motor. FIG. 15 is shown with the cover removed.

FIG. 16 illustrates in perspective view the relationship between the motor rotor, motor rotor core, bearing, and shaft, illustrating how the motor's rotor core contacts only the inner race of the bearing.

FIG. 17 is a cross-sectional cutaway view of the rotor housing showing a tight but noncontacting labyrinthine seal between the endplates and the inner walls of the rotor housing to prevent loss of pressurized air from the spiral volute and thus increase efficiency. This also illustrates the manner in which the aligned standoff projections help space apart the individual rotors of the rotor assembly.

FIG. 18 illustrates the manner in which the motor rotor core locks against a polygonal shaft or axle to the rotor of the motor.

FIG. 19 illustrates a multi-stage pump.

FIG. 20 illustrates a variation of the multi-stage pump.

FIGS. 21 and 21A illustrate cross-sectional views of an alternate preferred embodiment of the rotor assembly showing runner portion progressively thickening to the edge such that openings between the adjacent rotors are restricted to prevent pressurized back-flow through the rotors.

FIG. 22 is a perspective view of the device illustrating a rotor assembly positioned between adjacent bearing standards and the use of a dampening shaft coupler.

FIG. 23 is a perspective view illustrating a two bearing embodiment of Applicant's novel device. The rotor assembly's spiral volute housing is not shown in this illustration. This is a preferred embodiment due to the greater ease of balancing the rotor assembly with just a pair of bearings.

FIG. 24 illustrates an elevational side view of a rotor in an alternate preferred embodiment having four spokes, wherein the spokes are the same thickness as the runner portion and dimples or standoffs are used spaced apart from an identical pattern on an adjacent rotor. Because of the fixations of the rotors in the assembly at the stamped dimples, no central spacers on the shaft are necessary.

FIGS. 25A and 25B are elevational views showing a mold in alignment and a mold out of alignment for an understanding of how a molded rotor can be made imbalanced even when the axle-hole is dead-center.

FIG. 26 shows an imbalance in the rotor due to eccentric center of rotation due to improper molding as illustrated in FIGS. 25A and 25B.

FIGS. 27A and 27B show two rotor referenced marks included aligned 180° apart on successive rotors. FIG. 27A being a molded rotor with molded standoffs and FIG. 27B being a stamped rotor with dimple standoffs.

FIGS. 28A and 28B show periodic rotation of adjacent rotors around the axle shaft in accordance with the number of spokes, with FIG. 28A being a molded rotor with solid standoffs illustrating the even/even or odd/odd rule for spokes and standoffs in molded rotors. FIG. 28B illustrates a stamped rotor with the even/odd rule between spokes and standoff dimples to prevent successive and adjacent standoff dimples between rotors from coinciding and thereby destroying inter-rotor spacing between runner portions.

FIG. 29 is an exploded view of a molded standoff with a central perforation that can be used to spread glue or other fixation agents between adjacent aligned disc standoffs, fusing these rotors peripherally for a more rigid motor assembly.

FIG. 30 shows a top view of a disc showing the reference marked and stamped dimple standoffs.

FIGS. 31A and 31B illustrate the inverted ‘knife edge’ on the pump's volute (as opposed to FIG. 3 with the original low ‘knife edge’ that can be used with rigid standard bearings) that must be used when air-bearings or other autohydraulic bearings are used to prevent impact of the rotor assembly on the ‘knife-edge’ during startup before air-bearings fully pressurize.

FIG. 32 illustrates the use of a vibration isolator 49 between the axle bearing 45 and support standard.

### DETAILED DESCRIPTION OF THE PREFERRED EMBODIMENTS

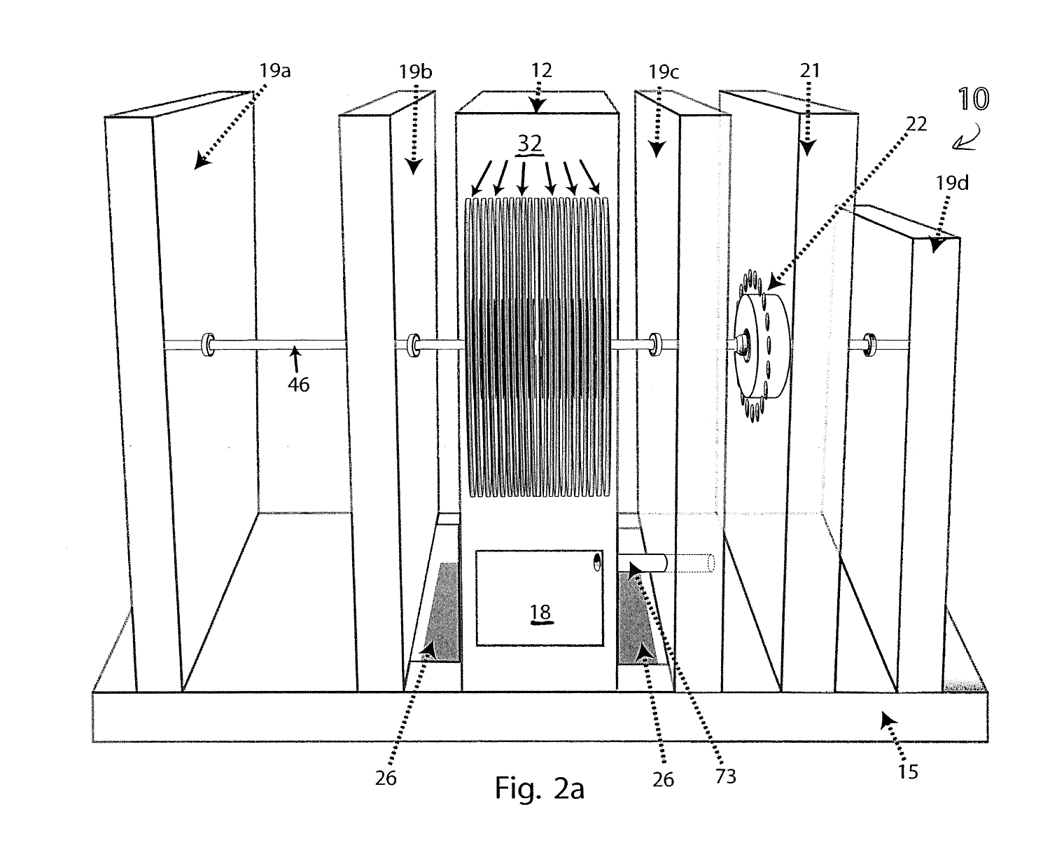

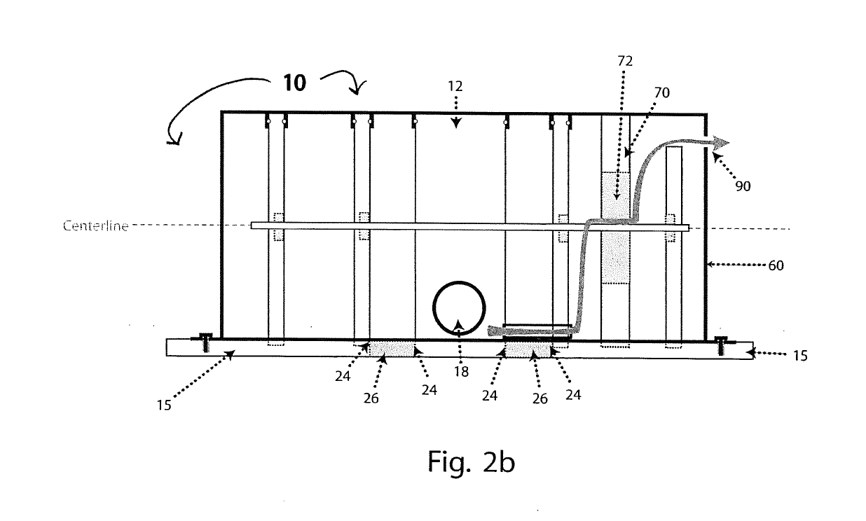

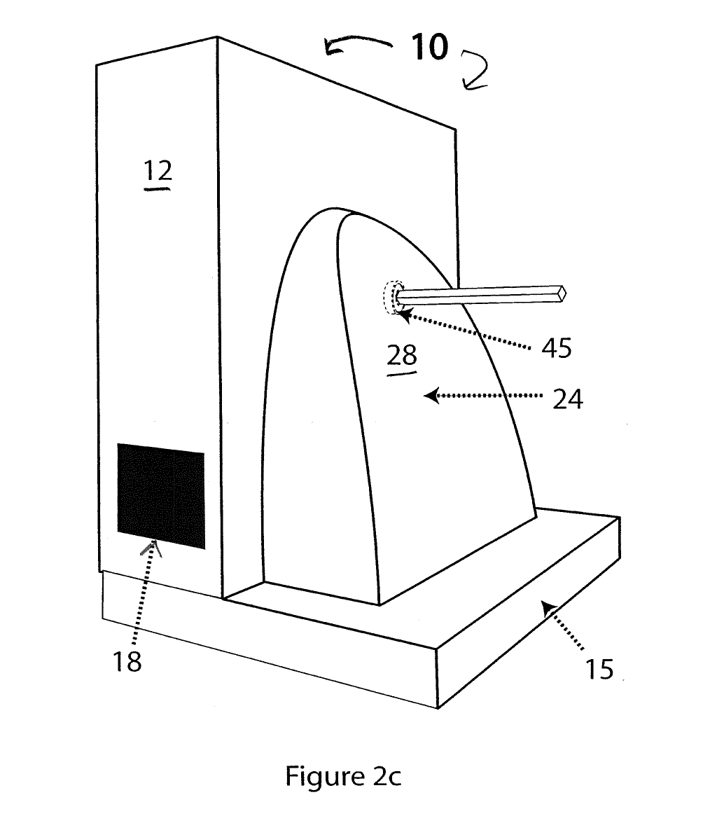

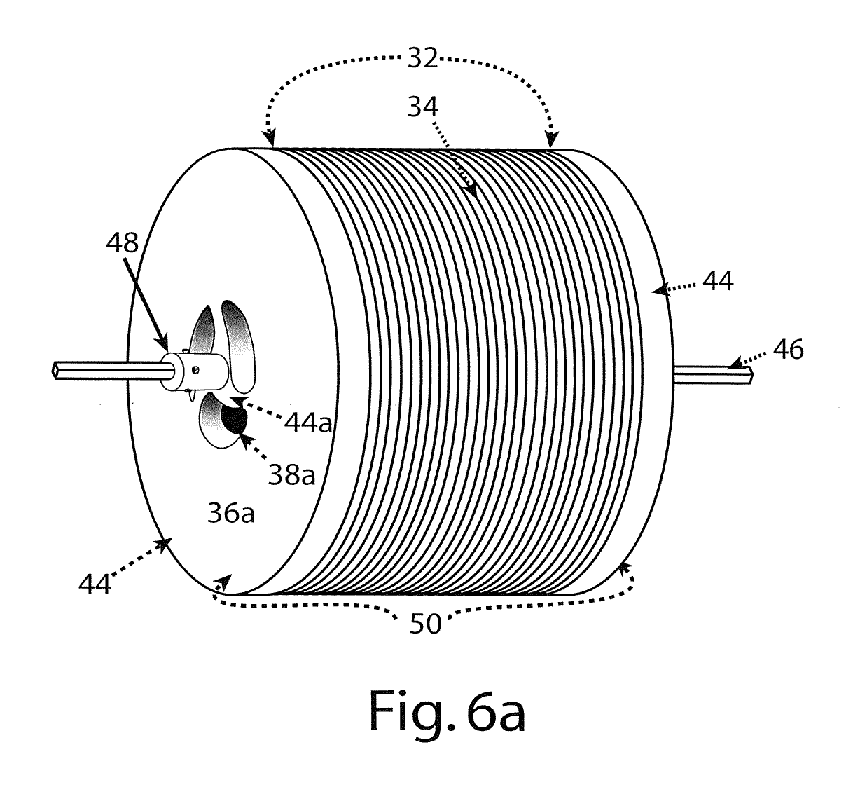

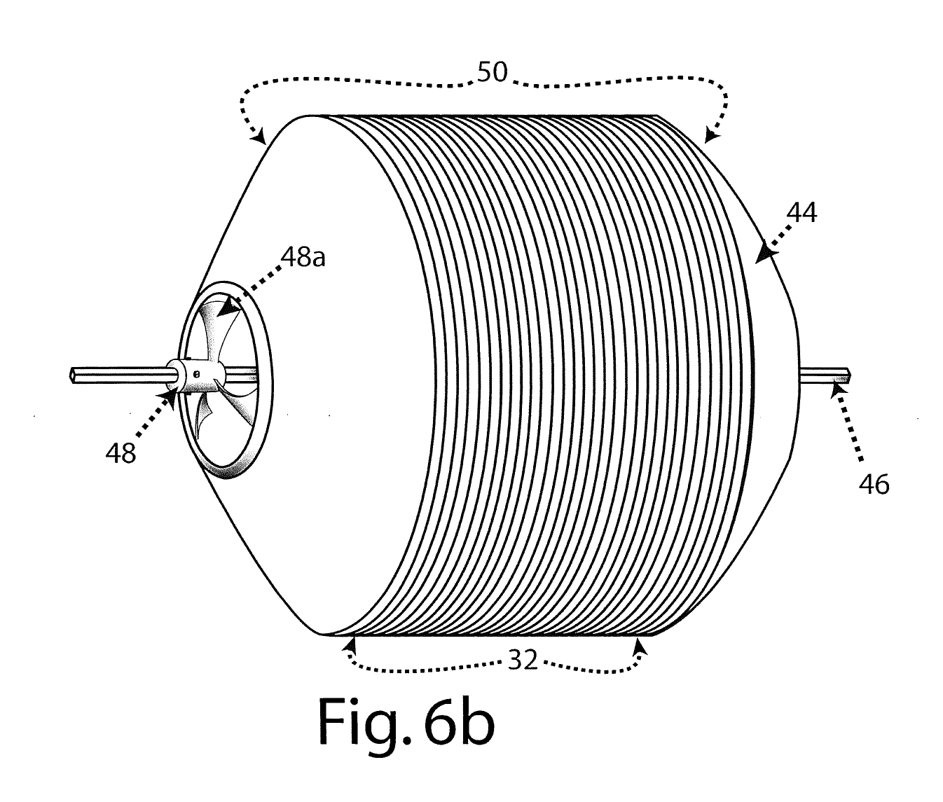

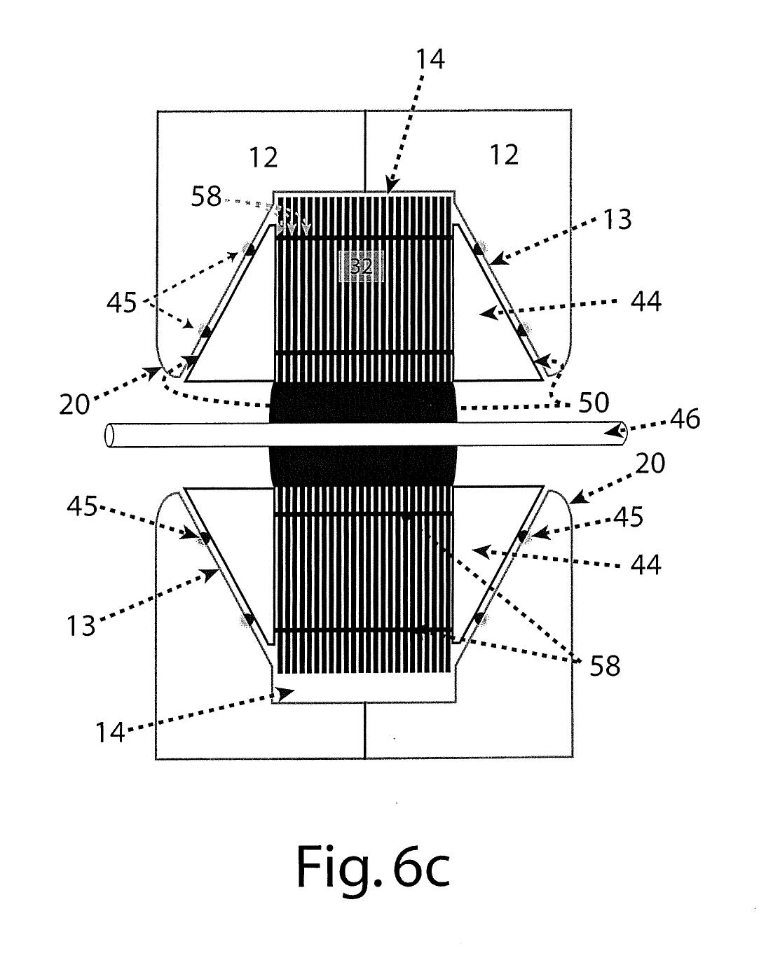

FIGS. 2a, 2b, 2c, 3, and 4 illustrate a bladeless pump 10 comprising typically: a rotor housing 12, including inner walls 13 (see FIG. 6c), the rotor housing including walls defining a spiral volute 14, the walls defining the volute also disclosing a “knife” edge 16 where the rotor assembly is close to the upstream inner edge of the fluid outlet 18, volute fluid outlet 18 volute shaped. Rotor housing 12 further includes walls defining a rotor feed opening 20, walls may be radiused to help maintain laminar fluid flow into rotor feed opening 20. The knife edge may be about 0.5 mil. (optimal) off the outer edge of the rotors 34, or in the range of 0.001 mil. to 250 mil. At speed, the rotor stack should not make contact with the knife edge of the volute.

Fluid inlet walls 24 which may be part of or engaged with a support base 15 include walls defining a fluid inlet 26 and fluid passageway walls 28 for carrying a fluid, such as a gas or liquid, from the fluid inlet 26 to the rotor feed opening 20.

FIG. 2c illustrates the use of fluid passageway walls 28 in which the cross-sectional profile area decreases as air is carried from the fluid inlet 26 to rotor feed opening 20. Fluid passageway walls 28 may also have a spiral shape with or without decreasing cross-sectional profile area to impart a vortex motion to the incoming air as it is delivered to and enters rotor feed opening 20. This may provide for more efficient feeding of air to the stack assembly 50 (see FIG. 6a).

Typically, the spokes 40 of the central opening of the disc line up such that the rotor central openings 38 also line up as a straight line. In an alternate embodiment (see FIG. 7), projecting pins 54 and their receiving indentions 56 are altered in their placement (slightly offset on the spoke) such that rotor central openings now describe a helical path to the central disc rotor in the rotor assembly 32 from both edges of this rotor assembly 32, this helical path oriented to the plane of disc rotation at speed. This way the rotor assembly 32 uses its spokes 40 to describe a helical path (much like the edges of a twist drill) from both sides of the rotor assembly 32 that then aids ingestion of air into the rotor assembly 32. Typically, a left-hand twist would be on one side and a right-hand twist on the other, which would meet in the middle. This may improve the efficiency of air ingestion into the disc rotors and thus overall efficiency of the turbine.

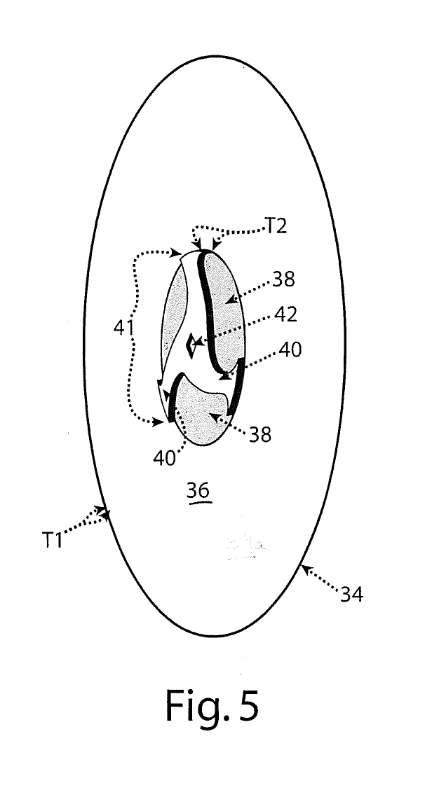

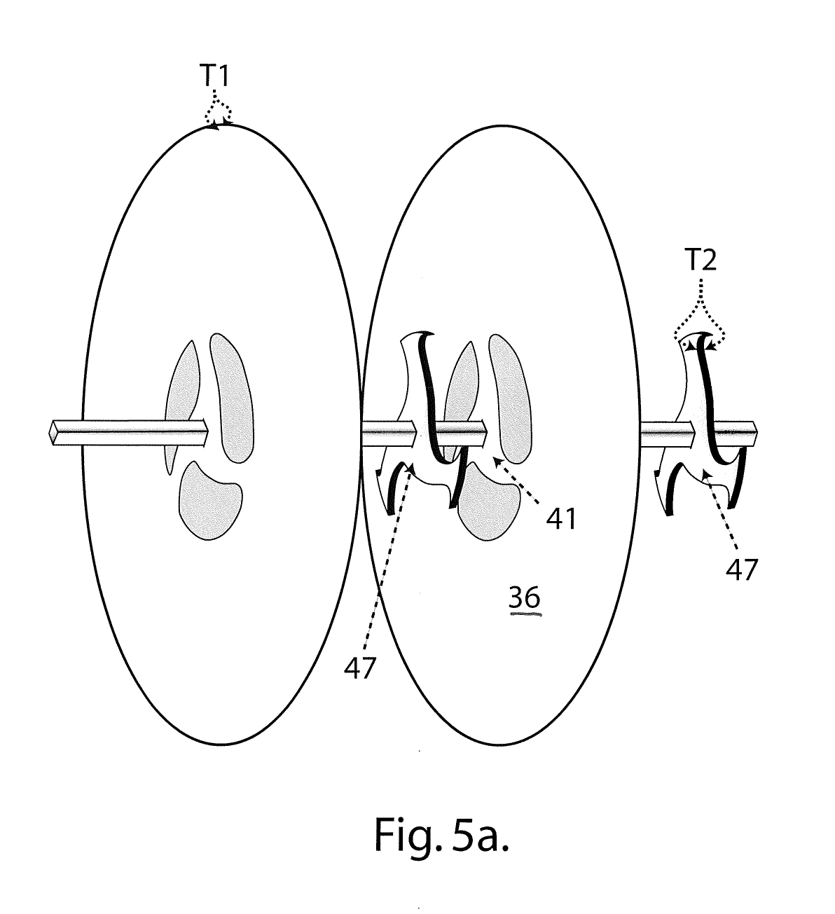

As illustrated in FIGS. 2a, 6a-c, 17, and 21, Applicant's bladeless pump 10 is seen to include: rotor assembly 32, the rotor assembly 32 having a multiplicity of disc-shaped substantially parallel rotors 34. As seen in FIGS. 5 and 5a, each rotor 34 includes a runner portion 36 on both sides. The disc portion 36 typically has a first thickness T1. Each rotor also has walls defining a multiplicity of central openings 38, transcribed by a multiplicity of spokes 40 as part of a spoke section 41, the spokes meeting at walls defining an axle opening 42. The spokes have a second thickness T2. The second thickness T2 is typically greater than the first thickness T1, the thickness difference defines the inter-disc spacing.

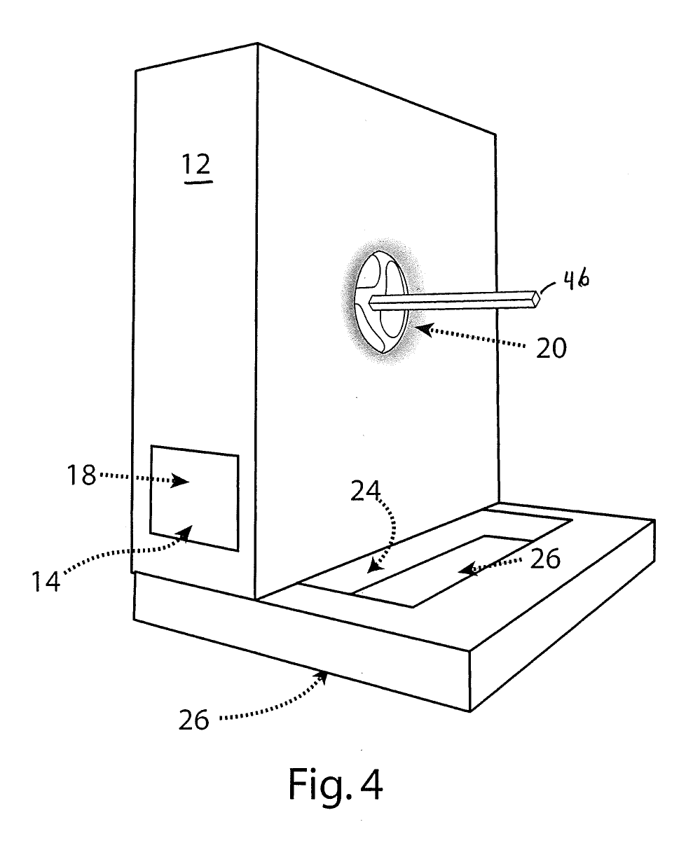

With reference to the above, it is seen that the rotor housing 12 locates rotor assembly 32 in a manner which maintains the parallel alignment of the multiple rotors to each other along with the alignment of the rotor assembly 32 within the spiral volute 14 and adjacent rotor feed opening 20 in such a manner so that there is minimum fluid seepage into the interior of the rotor housing, except through fluids (gases) passing through rotor feed opening 20. As the rotor assembly spins, air or other fluid is drawn through fluid inlet 26 into the rotor feed opening 20 (see FIG. 4) and into the rotor central openings, under a low pressure. Energy is provided to the fluid by spinning rotors 34 that will accelerate the fluid molecules in the inter-runner spacing into spiral volute 14 and out volute fluid outlet 18. Feed opening 20 may be radiused (see FIG. 4) for more laminar/efficient fluid flow.

It is seen in FIGS. 6a-6c, for example, that, optionally, a pair of endplates 44 may be provided at each of the removed ends of the rotor assembly 32, which endplates are typically, but not necessarily, thicker than the second thickness. These are designed to prevent warping of the rotors by applying a compressive force on rotor assembly 34 directed inward from the pair of endplates. The compressive force may be applied through retaining collar 48, which may be separate from or optionally be part of the endplate and affixed to axle 46 in ways known in the art (such as a set screw). Endplates 44 typically include spokes 44a, walls defining central openings 38a, runner portion 36a, and walls defining an axle opening 42a.

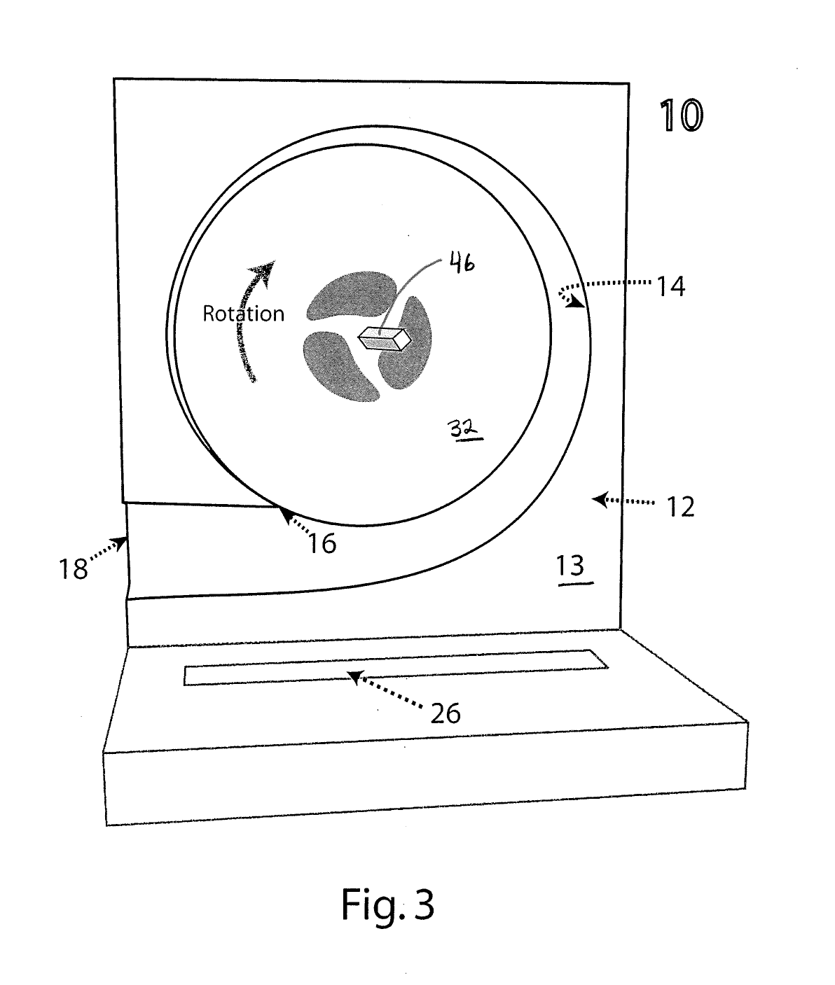

When multiple rotors 34 are entrained on axle 46 with the endplates 44 on the outside under compression and retained with collars 48, the rotors 34 and endplates 44 define a stack assembly 50, the stack assembly typically held under compression. The stack assembly is maintained within rotor housing 12, such that the rotor housing substantially encloses the runner portion of the stack assembly 50. Thus, as the bladeless pump is driven in the direction illustrated in FIG. 3, adhesion between the fluid and the walls of the runner portion will provide the propelling force for molecules adhering to the runner portion to move outward under the impetus of the power of a motor 72 (see FIG. 2b) spinning the stack assembly 50.

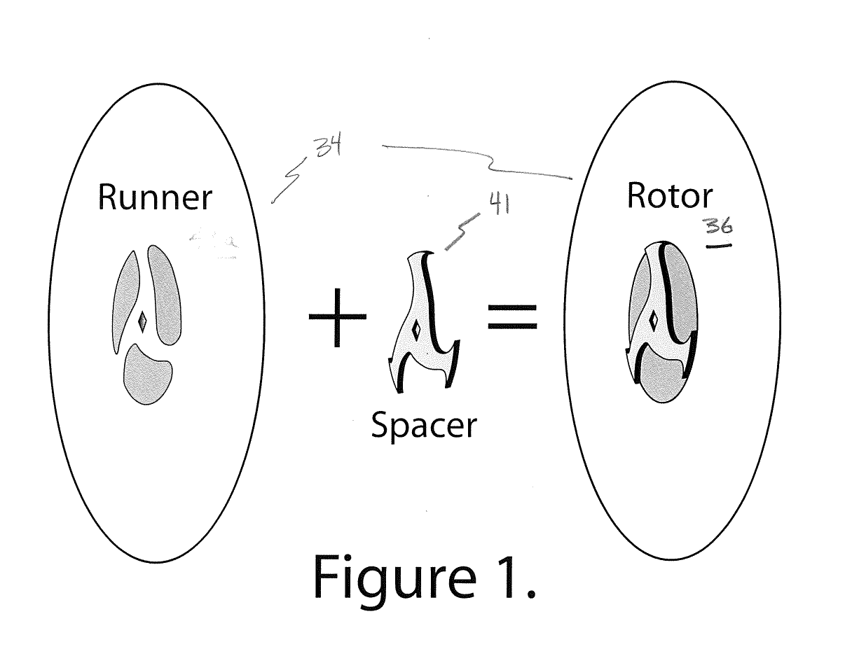

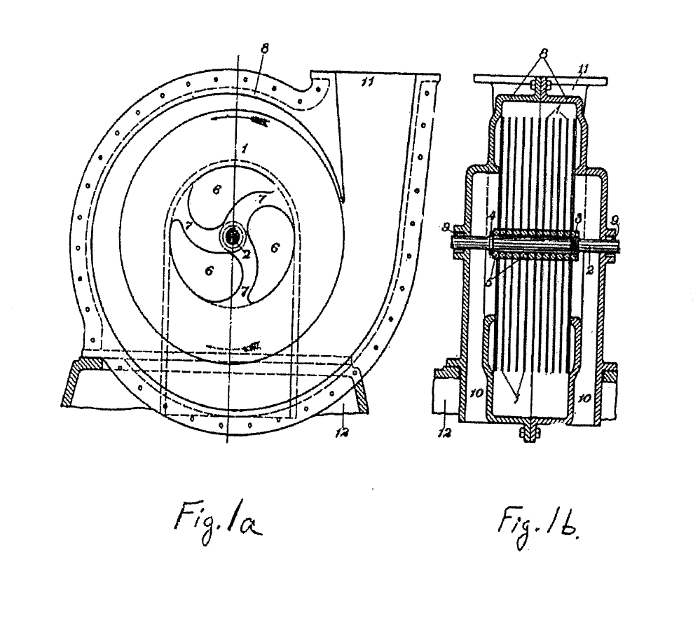

When endplates are not used, rotor assembly 32 have the rotors fused to or otherwise engage the axle and placed within the housing such that the central openings are adjacent the rotor feed opening as seen, for example, in FIG. 4, and as seen in the prior art FIG. 1B, to provide fluid communication to the central openings 38.

Spokes 40 of rotor 34 may typically include a means to lock the spokes in alignment through the use of projection pins 54 mating with pin receiving indentations 56 as seen in FIG. 7. Pins 54 may have a first shape different (here, a circular shape) from pins 54a (for example, rectangular), which receiving indentations 56 and 56a would have shapes substantially matching their opposite pins. On the other hand, the pin shapes may be the same, but in different positions on the spokes. Either way, the proper fit of pins into indentations would ensure that the alignment of the spokes would be proper. This is important as Applicant provides, in one embodiment, for a non-round axle 46, such as an axle in a polygonal shape. In certain polygonal shapes, alignment is important as the axle will not slide all the way through the axle openings if one of the discs is not properly aligned. For example, if the axle had a rectangular cross-section, the spokes, being typically radially equidistance one from another, one of the discs could be turned with respect to the others and strike the axle preventing it from going through as it would with properly aligned axle openings.

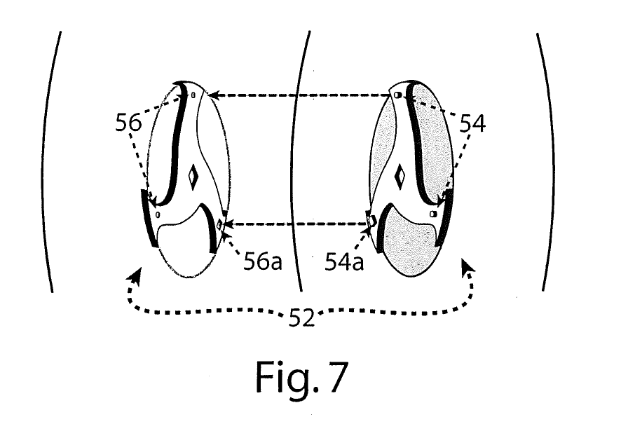

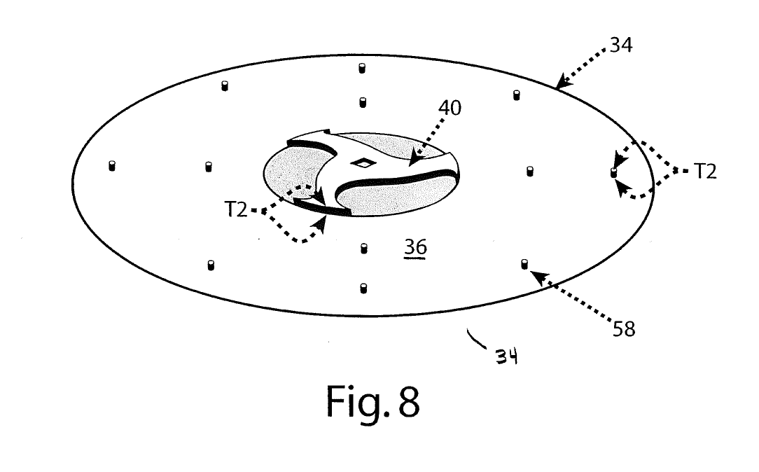

One side of each of Applicant's rotors 34 typically includes multiple bosses or standoffs 58 (as seen in FIG. 8 for example) typically integral with the disc portion, whose standoff thickness is approximately the difference between the first and second thicknesses. When the stack assembly is viewed with respect to the position of the standoffs 58 (see FIGS. 6c and 8), they may be seen to form one or more “circles” of standoffs at a radius from the axis of axle 46. Further, the standoffs may be positioned along a series of radial lines R as seen in FIG. 8, that is, lines drawn between the axle and the edges of the rotors. When viewed in cross-section in FIG. 6c, the standoffs may define two or more concentric circles. The function of the standoffs includes helping prevent the discs from flexing especially near the outer edges and helping straighten or flatten rotors that may be warped in the manufacturing process. One or both of the endplates may have a set of standoffs.

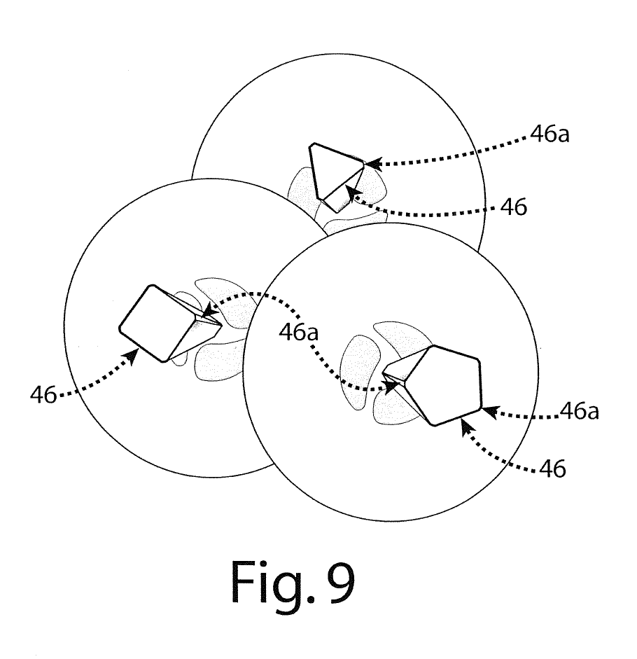

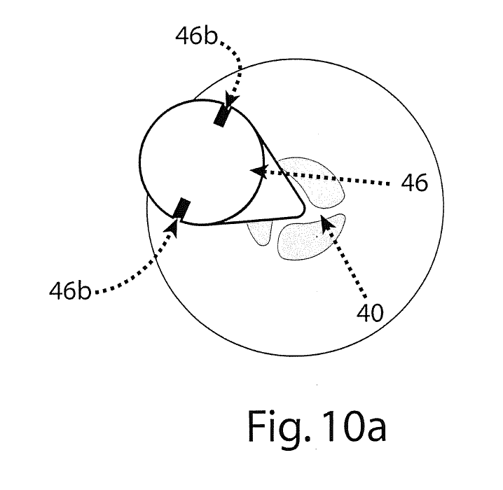

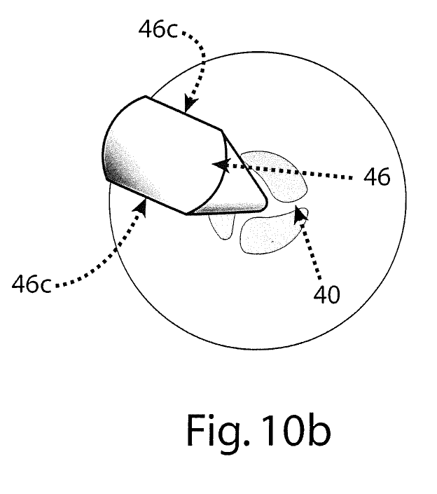

In one embodiment, as set forth above and in FIG. 9, axle 46 has a polygonal shape. Moreover, the corners of the polygonal shape may be faceted or broached 46a (see FIG. 9). This broaching will help avoid otherwise sharp edges between sides of a polygon and will help avoid fracturing or the concentration of forces at the otherwise sharp edges. The axle openings 42 in the rotors and endplates are shaped to fit snugly with axle 46. If axle 46 is round in one embodiment, all of the spoke sections 41 define at least one keyway along with a 46b keyway in the axle 46, and a key for engagement of the axle to the keyway in the spoke (see FIG. 10a). FIG. 10b shows a “dual broached” round axle 46c. In the case of stamped metal rotors, these may be fused to a completely round shaft by a glue or welding process.

Turning to FIGS. 6a and 6b, it is seen that endplates 44 may be dimensioned similarly to the rotors only thicker to help transmit the compressive forces to the multiplicity of rotors 34 contained there between or, set forth in FIG. 6b, or they may be planar conical shaped, thicker at the center and thinner near the edges. Moreover FIG. 6a illustrates the manner in which the endplates may engage the end rotors, so as the walls defining central opening 38a of endplates match up with the walls defining central openings of the rotors, and the endplate spokes 44a match up and align with the spokes 40 of the rotors 34. FIG. 6b also illustrates how a retaining collar 48 may include fanlike struts 48a connecting the collar to the endplate, so as to help accelerate air into the central openings 38 and 38a.

FIG. 6c also illustrates a manner in which compressive forces assist alignment and rigidity of the rotor assembly. Namely, Applicant's in one embodiment may provide bearing or glide surfaces 45 between the outer surfaces of the endplates and the inner walls of the rotor housing 12. Bearings, such as ball bearings, or glide surfaces 45 are also used to maintain proper alignment of axle 46 and stack assembly 50 (or rotor assembly 32 if no endplates are used) with rotor housing 12 preventing lateral motion of the assembly along the axle.

Individual rotors 34 and endplates 44 may be made of plastic composites or a ceramic material and may be made by machining, by the process of injection molding, metal stamping, or any other suitable process. Indeed, the rotor housing, base, and cover may be injection molded ceramic or plastic.

Each rotor 34 comprises disc portion 36 and spoke section 41 and may be manufactured as a single integral unit, again with the thickness of the spokes greater than the thickness of the runner portion. A second method of manufacturing (see FIG. 5a) comprises a multiplicity of rotors having a single uniform thickness of T1 comprising both the runner portion 36 and the spoke portion 41 with the addition of separate spacers 47 to separate one rotor from the adjacent other, which may be pinned to the adjacent rotor sparks to align them. For example, illustrated in FIG. 5a is the use of runners and spacers 47 which may be die cut from very thin materials, such as metal shim stock or extremely thin rigid plastic, such that the central openings will match up the runners and the spacers and the shaft. The separate rotors and spacers may be cut from different thicknesses and different materials. Thinner runners will reduce weight and improve rpm of the unit. Higher rpm tends to improve pressure and flow. Decrease in the thickness of the spacers may also improve pressure and increase the number of runners per inch of rotor stack. Thus, one die can cut out any thickness of runner and spacer, allowing much more variability in the flow and pressure a single turbine design can deliver.

The assembled stack of discs and spacers (FIG. 5a) or the integral units may be clamped together on a shaft and a wicking glue or other adhesive may be applied to permanently fix the discs to spacers 47 (or the rotors to one another if no spacers are used) and both to the shaft. Doing so, one may avoid the need for retaining collars 48, such as those illustrated in FIG. 6a. Gluing the axle discs and spacers together may also eliminate the need for endplates. The use of a single die to generate any number of different thicknesses of runners and spacers means fewer dies and equipment will be needed and additional expense may thus be avoided. That is to say, discs and spacers may be die cut from very thin material, such as metal shim stock or extremely rigid plastic, such that the axle holes will match up a disc and a spacer. That is to say, the rotors may have a disc portion and a spoke portion that has the same thickness, but use spacers 47 between adjacent disc and/or at the end of a rotor assembly, with or without endplates. Spacers may be cut from different thicknesses and materials. Decreasing thickness of the spacers improves pressure and increases the number of runners per inch of the rotor stack. Gluing together or otherwise affixing a number of rotors together and to the axle avoids the need for retaining collars to hold the stack to the shaft and the runners and spacers to each other.

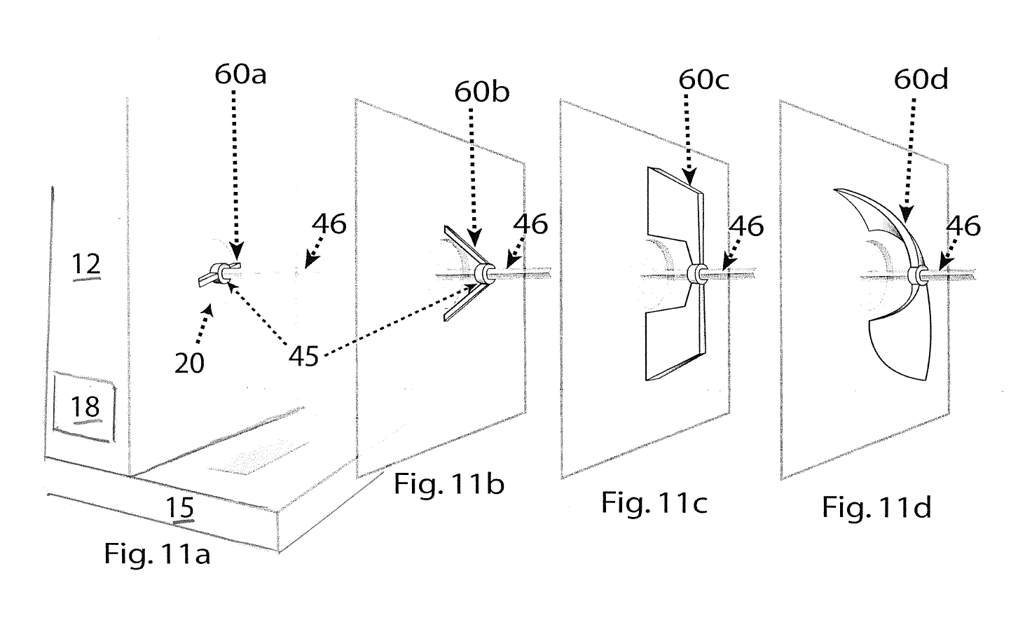

FIGS. 11a-11d illustrate a number of bearing configurations 60a-60d, for use in any embodiment, for rigidly mounting its bearing 46 to rotor housing 12 which itself may engage to a base 15. FIG. 11a illustrates a planar bearing assembly 60a that spans the rotor feed opening 20 and is in the plane thereof. FIG. 11b illustrates a strut braced bearing assembly 60b. FIG. 11c illustrates a straight vane bearing assembly 60c. FIG. 11d illustrates a vortex vane bearing 60d, which provides some rotation to the air entering rotor feed opening 20.

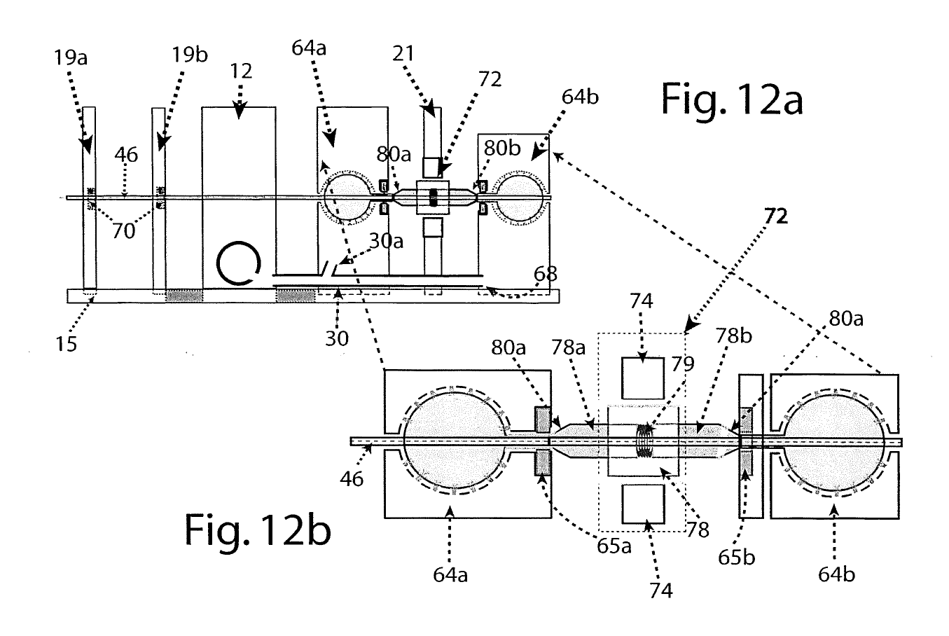

In an alternative preferred embodiment (see FIGS. 12a and 12b), the bearings may include, instead of bearings rigidly aligning the axle 46 with the rotor housing 12, an air bearing assembly including multiple bearings and a set of transition bearings 65a and 65. The transition bearings (which may be tapered bearings) will maintain the axle 46 in a fixed position during run-up and run-down of motor 72 and during an off position to prevent the rotor assembly 32 from impacting the ‘knife edge’ 16 of the spiral volute 14 at these times. Reference is made to FIGS. 12a and 12b that illustrate a set of air bearings 64a and 64b, along with transition bearings 65a and 65b, which operate in conjunction with a novel two-piece motor rotor 78a and 78b, the two piece rotor separated by a coil spring 79. Motor standards 70 maintain motor stators 74 in a rigid position. When motor 72 rotor is at rest, conical surfaces 80a and 80b of motor rotors 78a and 78b are, under urging of spring 79, pressed into transition bearings 65a and 65b. However, as the motor starts during run-up, pressurization at the air bearings through the multiple air pressure jets illustrated and through air flowing between the transition bearing and conical surfaces 80a and 80b will ease the compression of coil spring 79 and move the motor rotors 78a and 78b off the transition bearings so there is no surface-to-surface contact when the motor is at speed. Air bearings and transition bearings are known in the art.

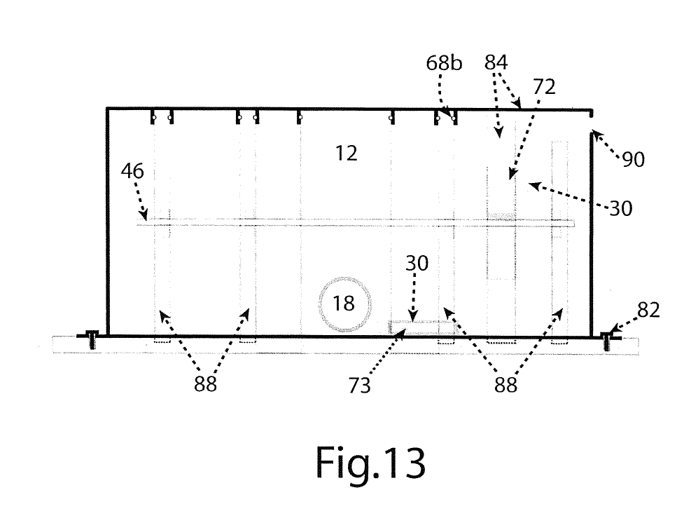

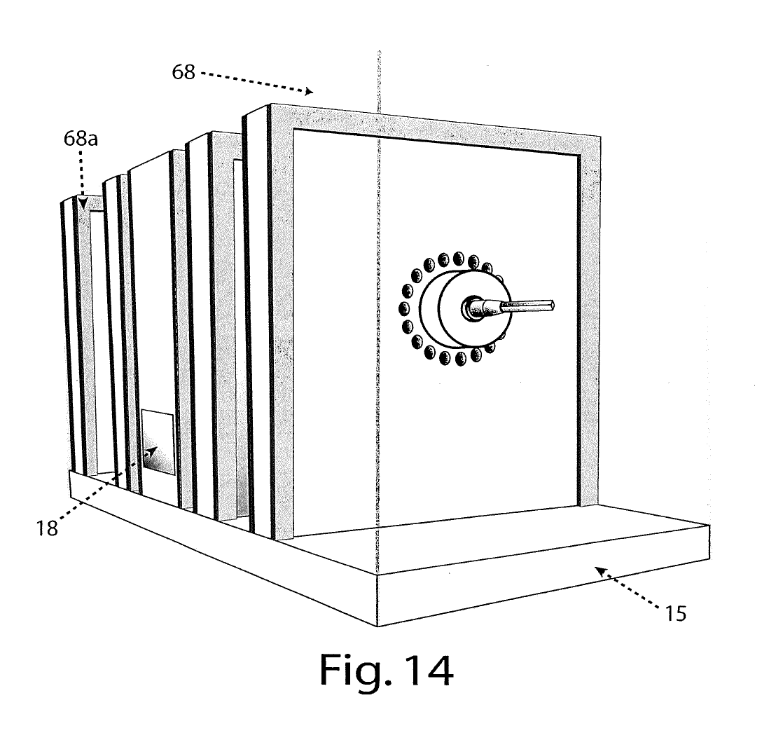

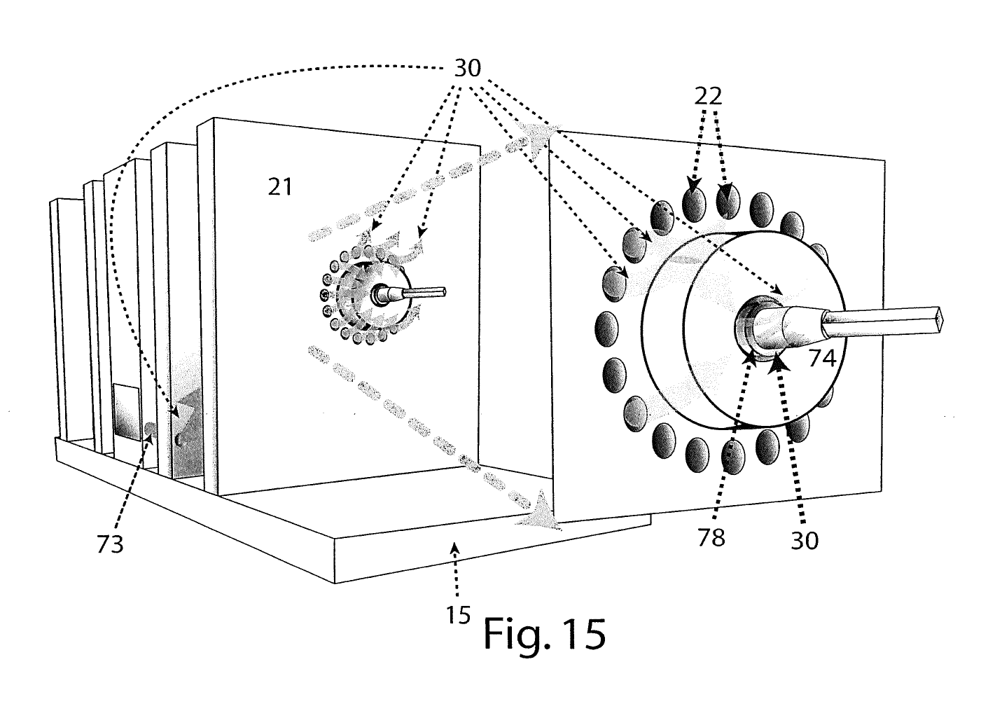

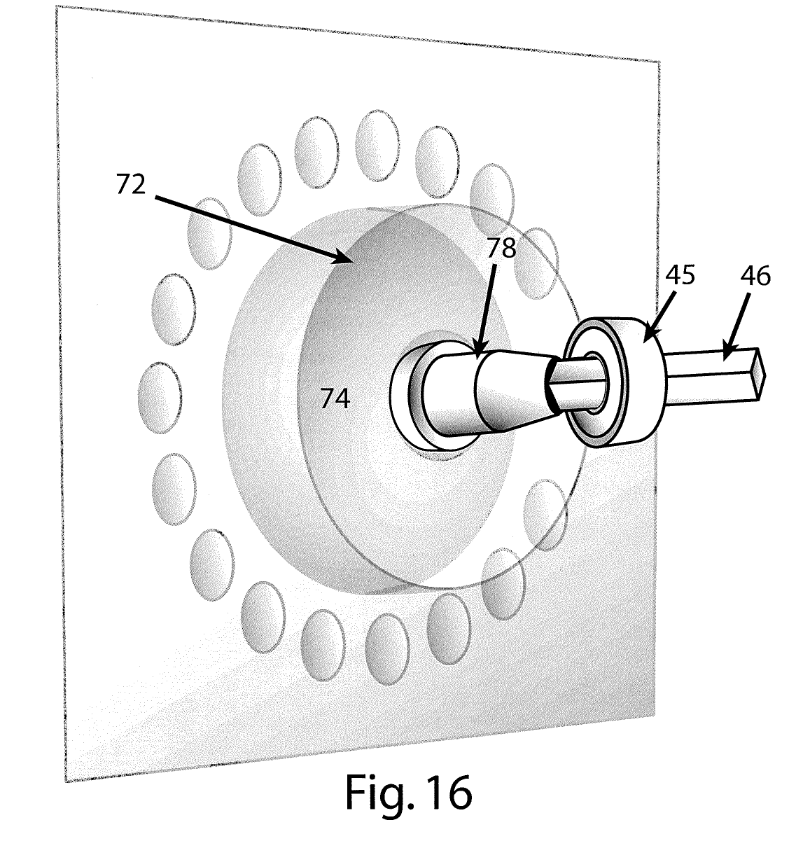

Turning now to FIGS. 2a, 2b, 13, 14, and 15, it is seen that a base 15 may be provided, the base engaging a motor housing 21, the rotor housing 12, one or more bearing standards 19a-19d, and a cover 68 for sealing to the base 15 so that the base/cover combination provides an air inlet 26 for providing air to the stack assembly or rotor and the spiral volute outlet. Note the use of the base/cover combination may allow for omitting passageway walls 28 and may comprise a portion of the rotor and motor housings. In addition, the porting or venting assembly 30 may be provided for transferring air under pressure from the volute to the motor housing 21 to cool the motor therein and then to expel such warmer air from a port 90 on the cover 68 which port 90 is located away or removed from the air inlet 26 (see FIG. 13). The use of the cover 68 and base 15 assembly to define the location of the intake of the air to the rotor assembly and to use some of the pressurized air or other fluid to cool the motor, and then to expel the coolant fluid away from the air inlet will help isolate the heat developed by motor 72 from the fluid drawn in and pressurized by the bladeless pump 10. If air bearing 62a and 62b are used, venting assembly 30 with vents 30a and 30b may be used as illustrated in FIGS. 12a and 12b to support the air bearings and compress coil spring 79 and for cooling. The use of cover 68, along with cover ridges 68a and elastomeric seal 68b combined spaced apart sufficiently to enclose the tops of the standards, housings or walls as seen in FIGS. 2b, 13, and 14, will help pneumatically seal and support the rotor and motor and the rest of the assembly. Elastomeric seals 68b will help firmly isolate (sound, heat, air, vibration) the motor from the pump so as to avoid air from the motor raising the temperature of air at the outlet opening. Insulation (spun fiberglass, foam, etc.) between the motor and rotor housing may also be used. The cover/base combination and the venting assembly is especially desirable when one of the objectives is to provide pressurized cool air at the volute fluid outlet 18. Note that the cover may have inner walls that fit snugly against the walls of the standards and motor and/or rotor housing. Cover 68 may have a fluid outlet opening 96 (see FIG. 13) matching and adjacent the fluid outlet opening of the rotor housing.

FIG. 17 illustrates the manner in which rotor housing 12 may include inner walls which are labyrinthine in construction matching a pattern for endplate outer walls 44b, so as to help restrict leakage from the pressurized volute chamber through the gap between the endplate outer walls 44b and inner walls of the rotor housing 12.

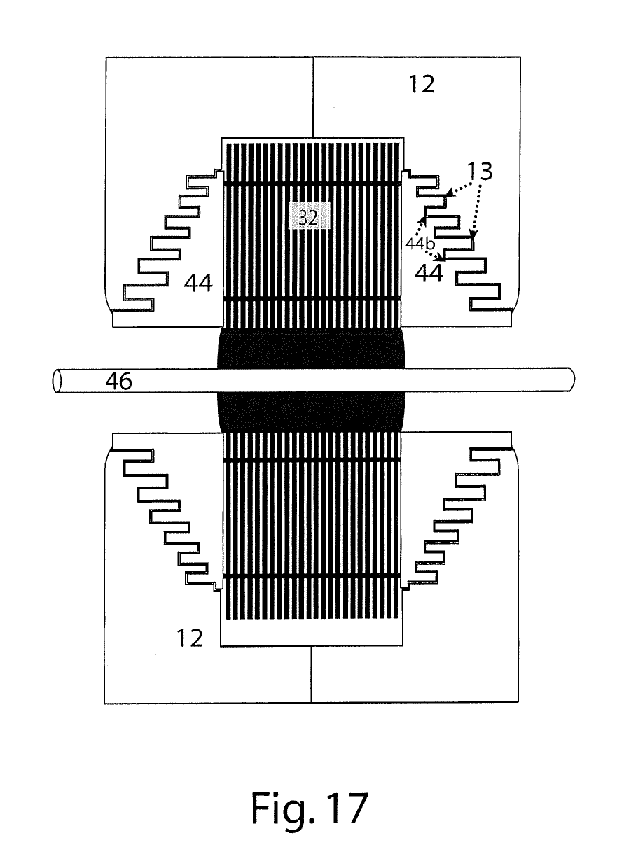

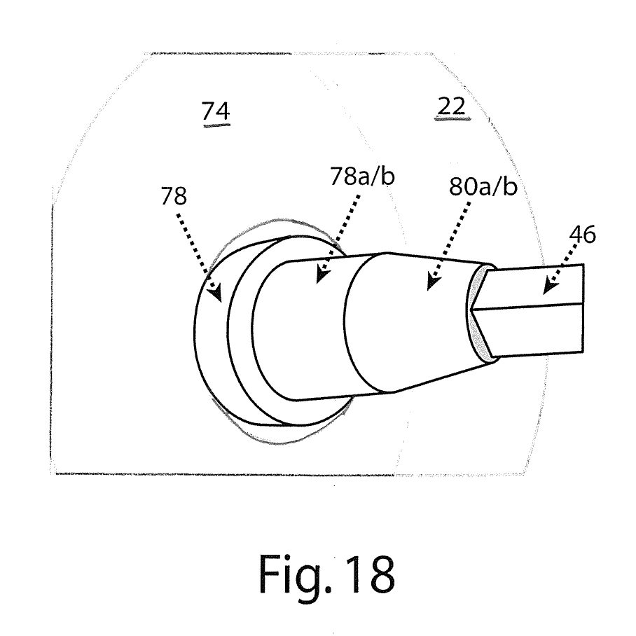

FIG. 18 illustrates the manner in which polygonal axle 46 locks into an appropriate dimensioned shaft in the motor rotor core 78a/b of motor 72, so that rotation of the rotor core imparts rotation to the axle and thus to rotor assembly 32.

FIGS. 2a and 2b also illustrate the manner in which one or more bearing standards, here 19a, 19b, 19c, and 19d, are provided sealed to base 15, which bearing standards hold the bearings to maintain the axle properly aligned to rotor housing 12, including a motor housing 21 for housing a motor 72 therein. It is seen how air from the pressurized volute 14 may be transferred to the motor housing 21 and passed into housing through vents 22 (on both housing walls). More specifically, coolant transfer tube 73 of venting assembly 30 may transfer pressurized fluid, such as pressurized air, from the volute to the motor in any manner, here through coolant tube 73 in motor housing 21 (see FIG. 13). However, in alternate embodiments, one or more tubes may be provided with outlets adjacent the motor rotor to help dissipate heat therefrom. Moreover, it is seen that air provided to the motor housing can pass out the port 90 as illustrated in FIG. 2B. Thus pressurized air is transferred from a pressurized volute to the motor and then out housing to be expelled therefrom in an area away from the air inlets in an effort to keep such heated air away from the air intakes of the pump.

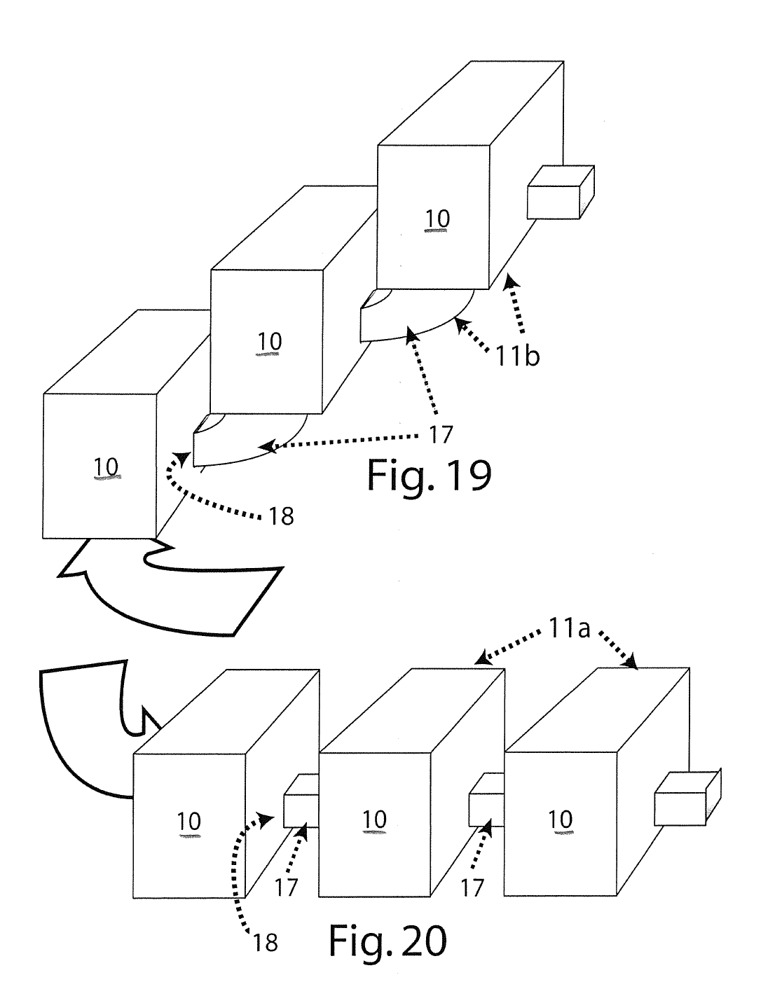

FIGS. 19 and 20 illustrate two multi-stage pump assemblies 11a and 11b. In a multi-stage pump assembly, multi-stage connector members 17 connect up two or more bladeless pumps 10, such that the volute fluid outlet 18 of an upstream pump feeds fluid inlets 26 of a downstream pump. Whereas air at ambient pressure may be present at fluid inlet 26 for the upstream most pump of the multi-stage pump assemblies 11a and 11 b, downstream pumps will have pressurized air presented to their respective fluid inlets 26. Three stage bladeless pump assemblies are illustrated, 11a placing the three pumps side-by-side (FIG. 20) and 11b placing the three pumps one above the other (FIG. 19).

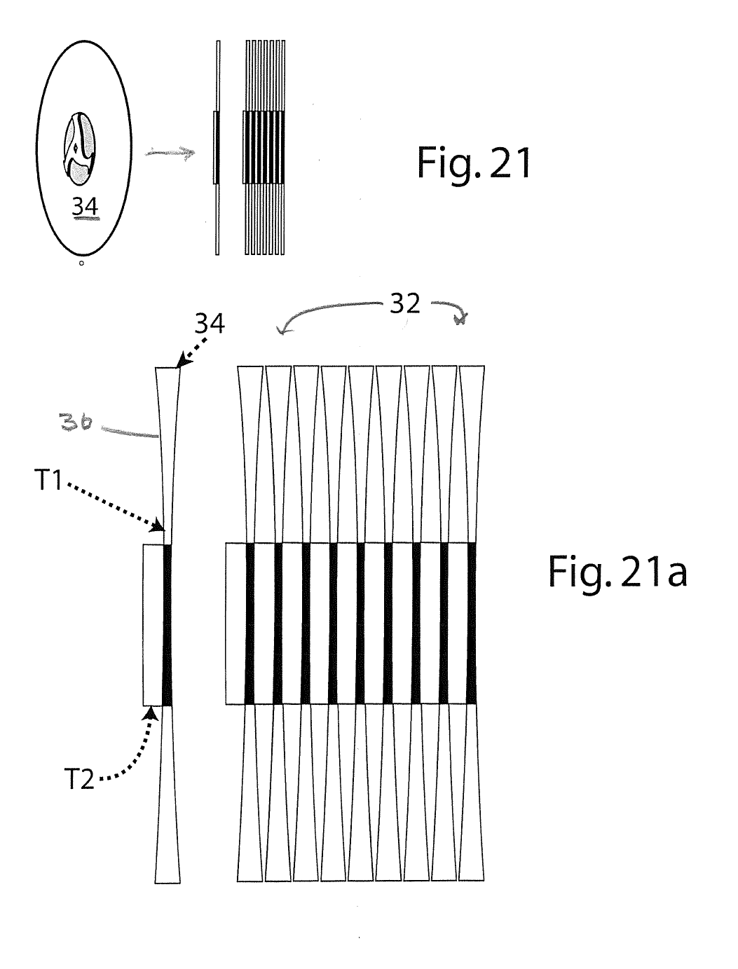

FIGS. 21 and 21a illustrate rotor assembly 32, wherein the profiles of each rotor 34 differ from those set forth in earlier embodiments. The earlier embodiments disclosed a rotor having a uniform thickness T1 (that is, the same thickness all along the runner portion). In FIG. 21a, the runner portion progressively thickens to its outer edge such that openings between adjacent rotors become more restricted. This forces some compression of the spiraling outflow of the fluid as it leaves the outer edges of the rotors creating a higher pressure differential as compared to the earlier embodiments.

Section 74 of the provisional describes FIGS. 21 and 21a and the cross-sectional profile of a modified runner designed for higher pressure operation. Here the peripheral edges of the disc are thickened, restricting the interdiscal gap toward the peripheral edge of the disc. This has the effect of restricting outflow through the interdiscal gap initially, but then (as pressure rises between the disc-rotors) this flow returns. The thickened outer rims of the disc-rotors then act to suppress the back-flow of fluid as it attempts to move back into the interdiscal space during operation. This promotes forward flow of the fluid at increased pressure. Some restriction of volume through the disc-rotor set may apply to this modification. This is a method of increasing fluid pressure of the BLT pump.

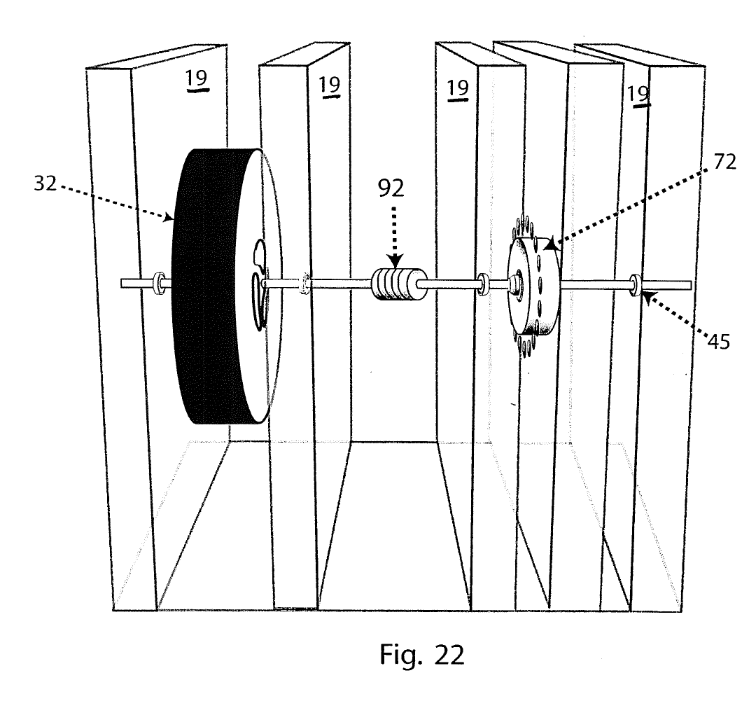

FIG. 22 illustrates a simplified version showing a disc rotor assembly 32, several standards 19, motor 72, and axle 46. More specifically, FIG. 22 illustrates a four bearing version having bearings, such as ball bearings rotating in bearing standards or roller bearings, to engage the housing and the axle, with a dynamic shaft coupler 92 to help dampen the vibration in the axle.

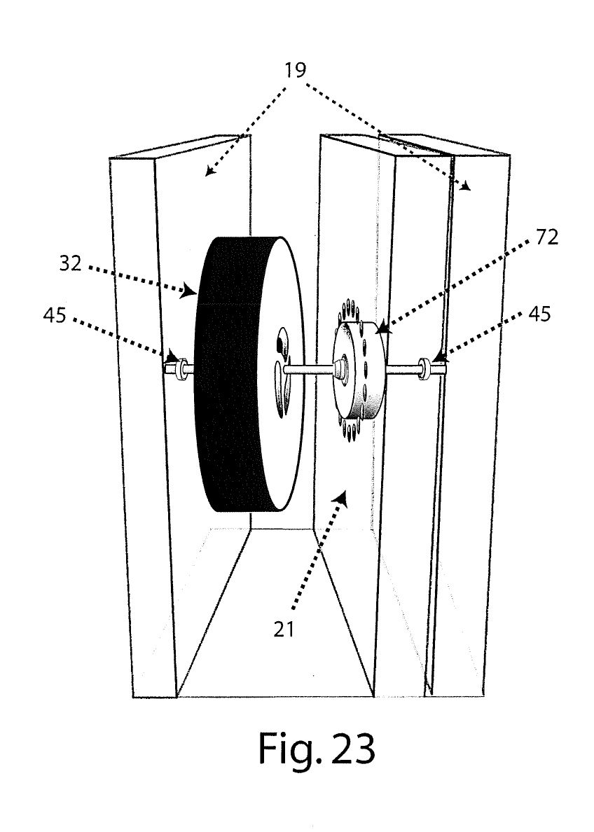

FIG. 23 shows a two bearing version with bearings 45, the bearing standards 18 engaged with axle 45, and having rotor assembly 32 (housing and base not shown) and motor 72 between the two bearings. There may be less vibration down the shaft and any residual vibration may be less in the two bearing embodiments and shaft/bearing alignment problems are eliminated. Also by having only two bearings, it typically becomes easier to dynamically balance the shaft. The axle may also be split and coupled with a flexible coupler that can damp the vibration. It can also reduce the noise level. Using a split shaft dynamic coupler 92 (see FIG. 22) will allow the motor rotor and disc rotor to be balanced separately and then connected after balancing via the standards.

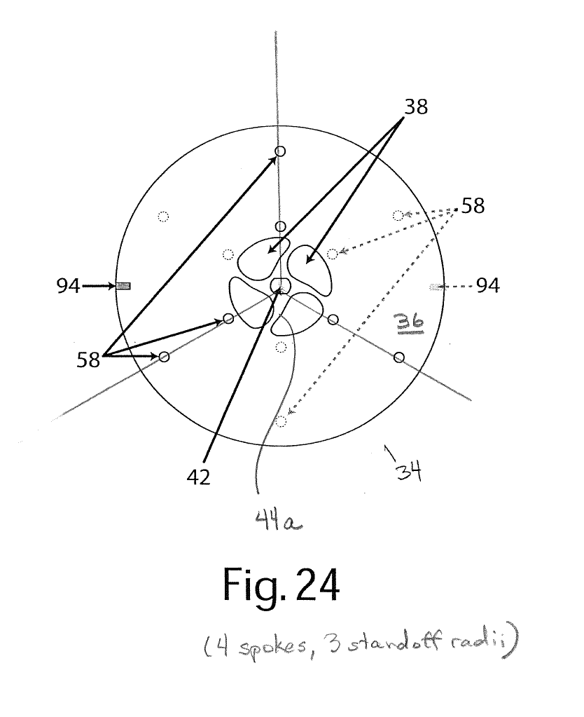

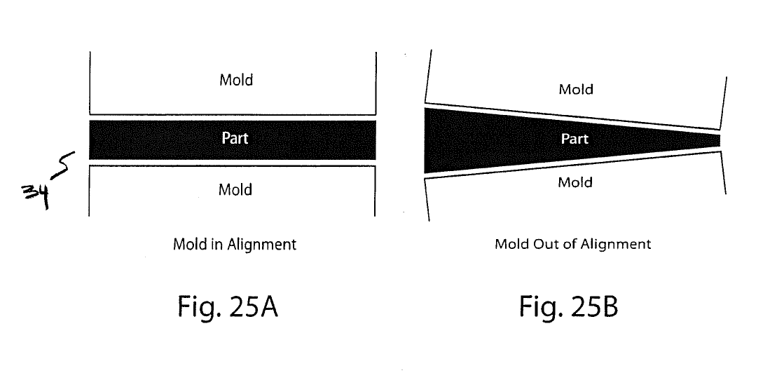

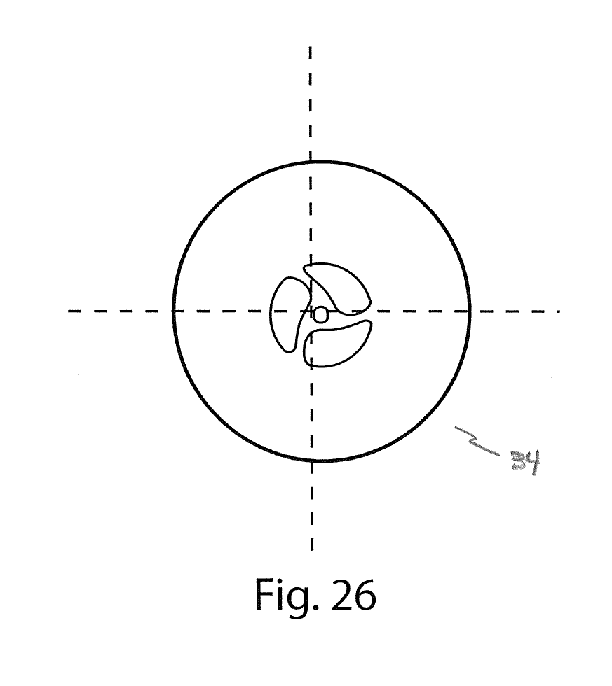

FIG. 24 shows reference marks 94 on the front and back for pre-balancing rotors. This type of pre-balancing is specific to the broached axle with two flat sides thus allowing a 180° fittiment. Rotors are subject to high rotary stress on the disc(s) at 30,000 RPM and above. Any imbalance due to eccentric centers of rotation for the axle or spokes/air inlets (FIG. 26) cause severe problems in balancing rotor assembly. These imbalances are minimized by careful execution of the injection mold or die (stamp) by the maker. More commonly manufacturing faults, such as the injection mold seating mal-alignment (as in FIGS. 25A and 25B), occur during a parts run from a mold out wearing. This results in uneven thickness of the produced rotor with the end-effect of throwing off the balance of the assembled rotor assembly 32, especially if all the thickened sides are aligned together, and all the thinner sides aligned along the shaft as well causing a shift of the center of rotor balance from the center of the axle hole.

The end result is a rotor where the center of axial rotational is eccentric to the center of the axle-hole. This results in a set which will not balance easily and running such imbalance will result in high vibrational stress capable of shaking the pump apart at high speed. No mold is perfect, neither in its execution at the hands of the mold-maker nor in its production of injected or stamped parts, especially as the mold wears with production. Thus subtly, or notably, imperfect rotor production (FIG. 26) is the norm with current injection-molding, stamping or other techniques for production of these parts. A simple means to balance out these eccentricities along the axis of the disc-rotor set greatly adds to the balance (and thus the longevity) of any bladeless pump.

To this end, rotors are manufactured with balance-neutral reference mark 94 to indicate its orientation from the mold or die in the manufacturing process. Presumably eccentricities from the injection-molding or die-cutting will be constant within any one setup and production run.

In this manner, eccentricities introduced in the manufacturing process are evenly distributed onto opposite sides of the axle, thus inherently balancing out those eccentricities and thus helping preserve the inherent balance of the rotor assembly 32. Such a set will therefore require far less balancing prior to assembly into the pump.

FIG. 24 illustrates a four spoke configuration of a rotor 34, including standoffs 58. Other standoffs 58 are shown ghosted, for the rotor underneath the other. The top rotor is seen to have two rings of three standoffs, the standoffs radially aligned in three radii; one of the first radius and the second set at a second radius greater than the first radius. Beneath the top rotor is the second rotor with the same pattern (ghosted), except rotated 180° (see reference mark to right), but with axle opening 42 still aligned to the first rotor. Furthermore it may be seen that axle opening 42 is broached (flat areas) so that the first rotor and the second rotor may be punched out of the same stamp, but rotated one with respect to the other 180° as they are inserted on the axle, which rotation would help balance out any defects in the manufacture of the stamped rotor. Reference mark 94 is provided to ensure each rotor is rotated 180° with respect to the adjacent rotor. In this particular preferred embodiment, four spokes 44a rather than three spokes are used in order to make sure the intake orifices and spokes 44a line up with the alternating 180° alternating assembly. Note that the angular standoff spacing is 120° to the next and, in this way, the alternating assembly means all “dimple” type standoffs on a touching rotor will line up with the flat portion of the adjacent rotor and not with each other, thus helping to insure the spacing function of the dimple standoffs in this stamped rotor is preserved.

Also illustrated in FIGS. 5a and 24, the function of the spacers 47 or integral thicker spokes may be supplanted or enhanced by the use of dimples or standoffs 58 stamped into the runner portion 36 of the rotor 34 in the case of a stamped metal rotor. Standoffs 58 may be in lieu of spacers 47 or thicker spokes. Such rotors 34 may be fused or welded to each other at the dimples or standoffs 58 and to the axle 46. This use of standoffs is especially helpful when the rotor assembly 32 is glued or welded to the axle.

In the case of metal die-cut or stamped rotors 34, the thickness of the dimples/standoffs 58 can be variably set in the die itself. Thus one die can be set to deliver precisely variable interdisc spacing, and thus can deliver many different variations. This may make producing turbine pump variations far more cost-effective.

Reference mark 94 may be added by stamping or injection molding, and its purpose is to ensure a 180° alternate or other pre-balanced alignment between rotors with an even number of spokes. Such an alignment is useful in cancelling any imbalance caused by eccentric placement of the axle opening 42 when alternate (180°) alignment between rotors is used throughout the rotor assembly 32. This ensures a more balanced rotor assembly 32. Standoffs may be punched or dimpled out of the rotor material as by stamping. In such a case, a depression may exist behind the dimpled standoff. Therefore, dimpled standoffs on adjacent rotors should be staggered and balanced. This is achieved in the odd number of standoffs/radii (here, three) (see FIG. 24).

In one manner, the fusing of the rotors to one another may be by a process of electrical flash welding. The set of rotors may be assembled on their axle and placed under compression such that all standoffs touch an adjacent disc. An anode electrode may touch all discs at the periphery while a cathode may be attached to the axle. When this assembly is immersed in argon, other inert gas or vacuum and the appropriate welding electrically discharge is applied, effective spot welding of the standoffs that are adjacent the flat portions of the rotor may occur instantaneously and result in rapid and rigid construction of the rotor set on the axle.

FIGS. 25-31 describe some problems encountered with the manufacture of disc-rotors for bladeless pumps and engines, and how any imbalance of rotor assembly 32 set on the axle, caused by miss-steps in manufacturing, can be overcome by these described methods of assemblage of the rotors on the axle

Problems include, generally, uneven thickness of rotors caused by improper seating/wearing of its injection mold or variations in foil thickness in the case of stamped rotors. Another problem is eccentricity of the axle hole in the injection-mold or stamping die.

Bladeless pumps 10 rely on extremely high RPM for their efficiency. Subtle, even unmeasurable variations in disc-rotor thickness and/or eccentricity of the axle-hole placement become magnified exponentially with increasing RPM. For this reason, these methods of rotor assembly 32 will act to minimize those variations from perfection necessary to produce a balanced rotor assembly 32 on axle 42 in bladeless pump 10. As RPM increases and imbalances are magnified exponentially, these methods of assembly of the disc-rotor set become that much more important.

When dimples are used as stand-offs 58 (see FIGS. 24, 27B, 28B, and 30), it is important to ensure the convexity of the dimple on one rotor touches only the flat portion of the adjacent rotor (dimples on adjacent rotors non-aligned). If an odd-number of spokes are used, then an even number of stand-off/radii may be used (or vice versa). This results in no two dimples being superimposed over each other in successive rotors and thereby preserving the interdiscal spacing function of the dimple stand-offs. If these are molded stand-offs (and therefore no concave back-surface for another dimple to fall into), the standoffs on adjacent rotors may be aligned.

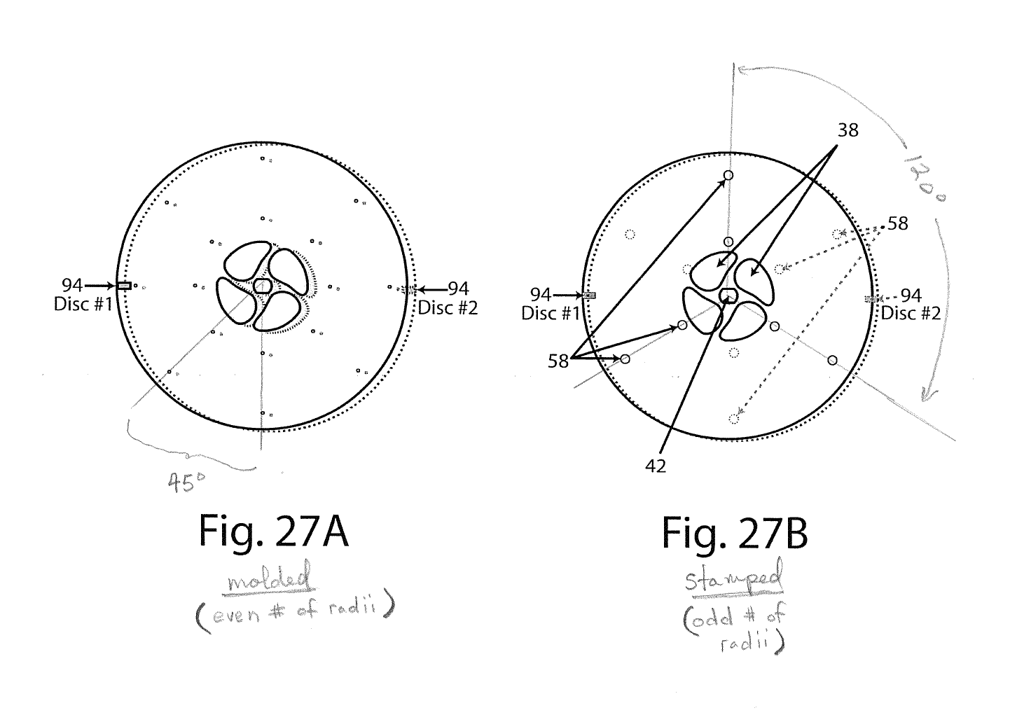

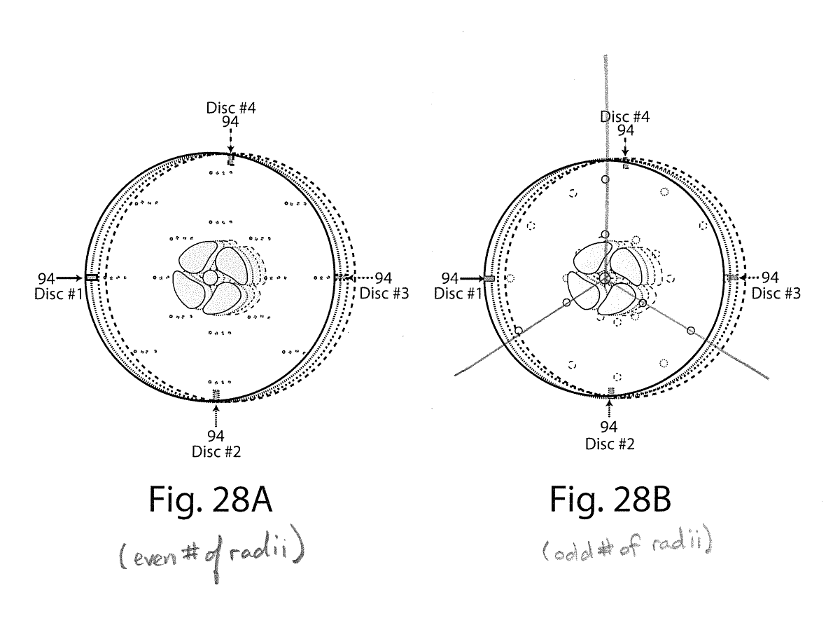

FIG. 28A (even number of standoff/radii) illustrates the same pre-balance principle of reference mark rotation every 90° as described above for injection-molded rotors applied so molded standoffs in adjacent rotors will coincide and preserve interdiscal spacing. FIG. 27B illustrates stamped rotors without a T2 spoke thickness where interdiscal spacing is preserved only when the convexity of a stamped standoff dimple falls against the flat portion of the adjacent rotor.

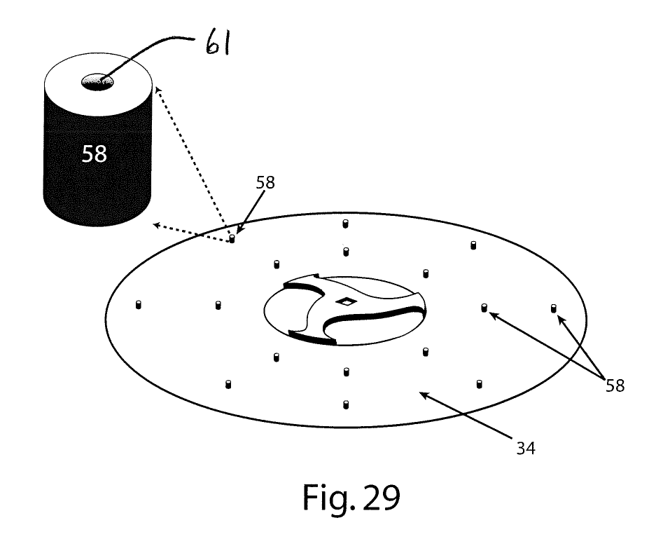

FIG. 29 represents a consideration for injection-molded rotors whereby a central perforation 61 is incorporated into each rotor and where such stand-offs are designed to line-up against each other in successive rotors, so as to allow a fixing agent (glue, etc.) to be injected peripherally and thus fix all molded standoffs to each other, preserving periphery rigidity of rotor assembly 32.

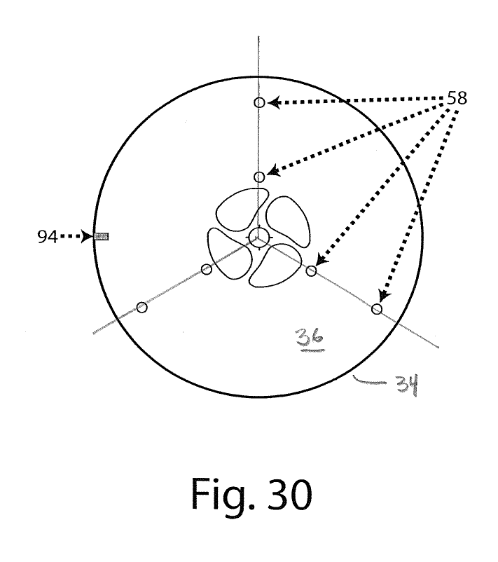

FIG. 30 also is a single representation of a stamped disc-rotor with its stand-off dimples (odd numbered radii) incorporated with an even number of spokes in the rotor. A reference mark is also incorporated into the rotor.

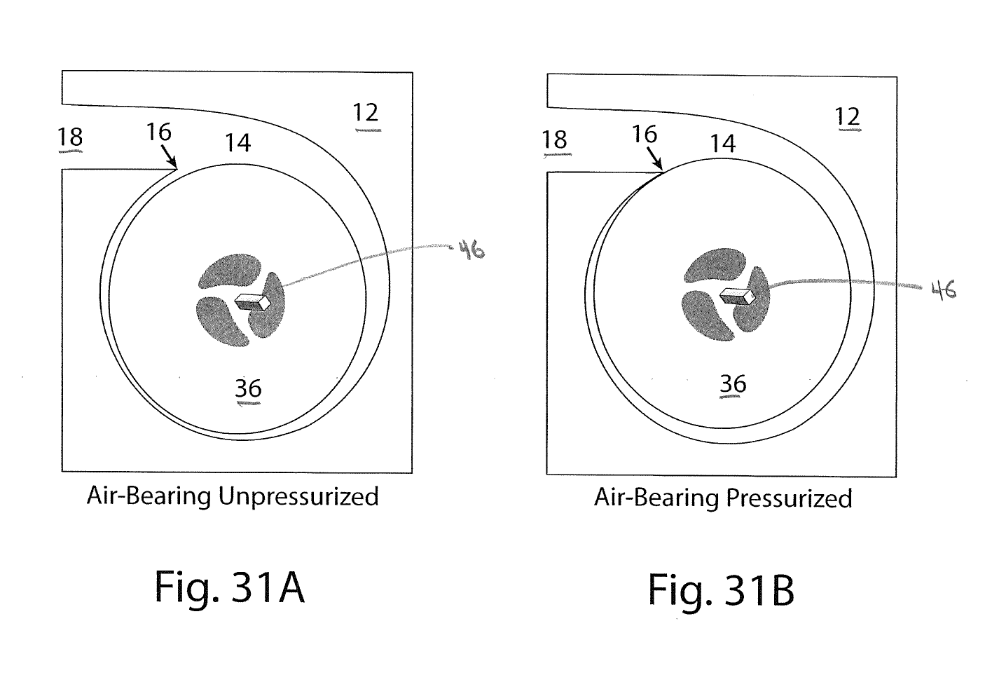

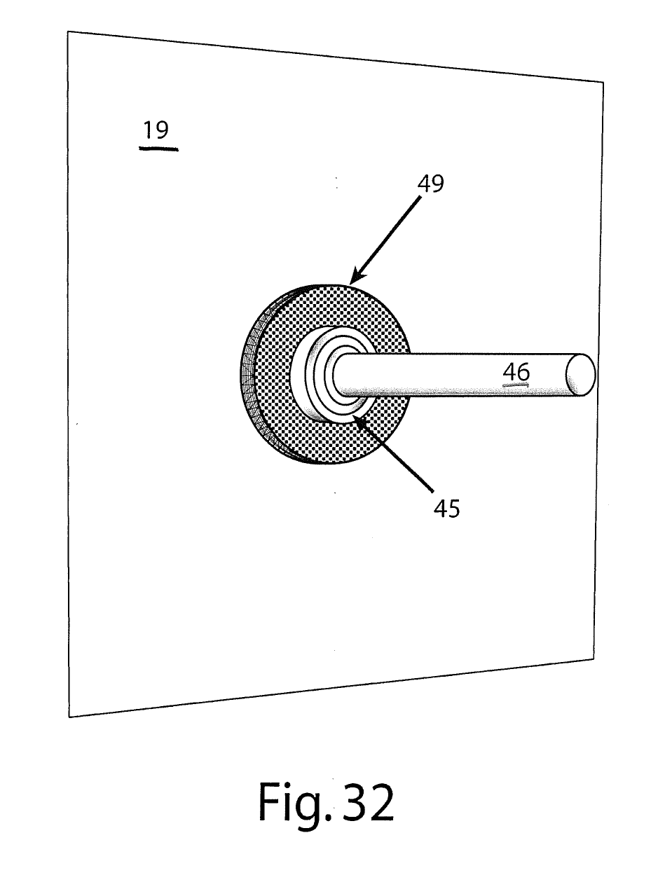

FIGS. 31A and 31B illustrate the requirement of powered air-bearings or autohydraulic bearings when incorporated into the bladeless pump or engine—the spiral volute must have its exit portal gravitationally above the level of the axle and ‘knife-edge’. FIGS. 31A and 31B apply air-bearings/autohydraulic bearings only and prevents impingement of the rotor assembly on the ‘knife edge’ during startup and run-down.

In pre-balancing, applicant refers to the irregularities in the rotors that often come with the sides of the thermoplastic rotor mold not being precisely parallel (as shown exaggerately in FIGS. 25A and 25B) or irregularities in the rolled foil used in stamped rotors. Therefore, rotor produced will not have the precise exact thickness (and therefore mass) as its opposite side. If all the sides line up on the axle such that all the heavy sides are together opposite the lighter sides together, the imbalance will be severe and therefore more difficult to balance on a dynamic balancing machine. If successive rotors are alternated with reference marks on opposite sides or equiangular, any light vs. heavy issues with manufacture of the discs will then be equally distributed to both sides of the axle—the pre-balancing—that then makes the actual dynamic balancing later much easier and less severe on the rotor assembly 32.

Similar issues are resolved when the number of spokes (4) and a round axle (to which the discs may be flash-welded) allows a 4-position angular rotation of the rotors for an even more effective pre-balancing with a 90-degree rotation in the same direction between successive rotors, as illustrated in FIGS. 28A and 28B. This can apply equally well to a round axle with flash-welding of metal foil rotors or injection-molded rotors with a square axle and four spokes made of thermoplastic or ceramic.

Pins 54 and corresponding recess 56 (see FIG. 7) on even-numbered spokes 40 must allow for at least two opposite alignments of the rotors such that the reference marks included at manufacture can be aligned 180° apart on successive rotors 34 (FIGS. 27A and 27B). With an even number of spokes and the rotors aligned 180° apart, all spokes will still line up and preserve without encroachment of the central air passages by spokes of the rotor assembly 32.

Two opposite alignments' refers to four-spoked rotors with a broached (2 flattened sides) axle-hole, as shown in FIG. 24 and the two alignments shown in FIGS. 27A and 27B. FIG. 27A is for molded thermoplastic or ceramic stand-offs which should line up to maintain disc-rotor separation. FIG. 27B illustrates stamped dimple stand-offs with concave backs. These dimples should NOT align if proper rotor separation is to be maintained).

Also, there may be a rotation of the adjacent rotors 34 around the axle 46 in accordance with the number of spokes (FIGS. 28A and 28B). A standard 3-spoke rotor can be rotated around the axle such that each rotor is 120° apart. In this example, reference mark 94 will make a complete rotation around the axle every 3 discs. Thus, a 3-spoke rotor will have a pre-balanced rotor set of 3 rotors, each in successive 120° rotations, regardless of the total number of rotors in the rotor assembly 32. The pre-balanced rotor set for a 4-spoke rotor may be 90° apart or else 180° apart in successive rotors with a rotor set of 4 rotors at 90° successive rotation (FIGS. 28A and 28B) or alternately 2 rotors at 180° successive rotation (FIGS. 27A and 27B). A 5-spoke rotor may have a rotor set of 5 rotors with a successive rotation of 72° (360/5) on successive rotors.

A 6-spoke rotor may have successive rotations of 60°, 120° or 180° on successive discs in the disc-set, with corresponding rotor sets of 6, 3, and 2 discs/pre-balanced set respectively as aligned into the rotor assembly on the axle. And so on with even higher number of spokes in each pre-balanced disc-set. An even number of spokes results in multiple possible disc-sets with sets equal to the number of spokes or factors of that number as seen in the 6-spoke disc-sets above.

Molded discs incorporate reference mark 94 in the injection mold such that all produced rotors produced from that mold will reference that orientation. Any eccentricity from that mold is therefore also marked (see FIG. 27B).

Reference mark 94 may be incorporated into the stamping die (or stamp) or injection mold. This marks rotors to indicate orientation to the manufacturing die and therefore marks any eccentricity of that die (FIG. 26). A pair of stamped rotors with standoff dimples and reference marks oriented 180-degrees apart is shown in FIG. 24, but FIG. 26 indicates the balance point of the rotor does not match the center of the axle-hole, thereby creating an unbalanced rotor—an imbalance that can be ameliorated by pre-balancing the rotors on the axle. It also can represent a miss-stamped rotor such that spokes and axle-hole are off-center. Again, this shows a use for pre-balancing.

Reference mark 94 allows consecutive rotors 34 (by any means of manufacture) to be placed on axle 46 in opposition (or some other angular distribution of that mark, such as in FIGS. 28A and 28B), such that eccentricity induced at manufacture of the rotor can be balanced out along the shaft as pre-balancing of rotor assembly 32.

Note also that a reference mark can be inferred. In an even/odd arrangement of spokes and standoffs, there may be one point where spokes and standoffs lie in the same radian (or some other identifiable arrangement) that comes from the molding or stamping of the rotor during production. This arrangement can also be used as a reference mark for pre-balancing during rotors assembly on the axle.

Perforated standoffs 61 (usually for injection-molded discs only) are shown in FIG. 29. Standoffs 58 may have central perforations 61 (pinholes) through both standoff and supporting rotor 34 which, when assembled as a rotor assembly, align such that a hollow needle may pass through all standoffs at once, dispensing a fixation material (such as an adhesive or fusing solvent) equally through all standoffs, fusing the standoffs and thus their rotors into a fixed orientation and interdiscal spacing. The enlargement of the stand-off shows the central hole through which the needle may be passed after the rotors are placed into an assembly. As these are molded stand-offs, they must line up between adjacent rotors when assembled, and this is when the fusion glue or solvent glue may be injected through this central hole and thus spread to all stand-offs immediately behind it in the rotor assembly 32. This leaves a more peripherally rigid and efficient rotor assembly 32.

Indentation or dimpled standoffs (as may be found in stamped rotors) are shown in FIGS. 24, 27B, and 28B. Standoff indention positions on each stamped disc should not coincide on adjacent discs. If they do, one indention will sink into the adjacent indent and thus fail to maintain the interdiscal space. Spokes 40 must line up with rotation of the rotors around the axle-line, an even/odd rule may apply to numbers of spokes and indents, such that rotors with an even number of spokes may have an odd number of indents radii or vice versa. In this manner, indents will only line up with the planar surface of adjacent discs and never with another indent. In this manner, indents will preserve interdiscal spacing and rotor alignment along the shaft.

Pre-balancing may be achieved by rotating successive discs onto opposite sides of the axle in disc-rotors with even numbers of spokes. Otherwise, successive discs may be indexed in a rotation=360°/number of disc spokes or a factor thereof to also achieve pre-balancing within any referable subset of discs in the disc-rotor assembly.

This design combines the function of the disc (Tesla's runner) with the spacer into one unit at manufacture. This is true of the molded rotors with T1 for the disc portion and T2 for the spacer portion at the spokes. It is equally true of the stamped version where there is no spacer function at the spokes, but this function is taken over by the stamped dimple standoffs in to periphery preserving that interdiscal spacing that the spacer (and molded standoffs) performs in the molded version. Molded rotors have aligned molded standoffs in the periphery of the disc to maintain interdiscal spacing there (and may be fused to increase peripheral rigidity). Stamped rotors should have nonaligned dimple spacers to maintain peripheral interdiscal spacing. These also may be welded or otherwise fused to increase peripheral rigidity.

Inversion of pump 10 fitted with air-bearings such that the volute's “knife-edge” 16 is above (as reference to gravity) rotor assembly 32 (FIGS. 31A and 31B). This relationship is such that as the air-bearing becomes pressurized and the shaft holding the rotor assembly rises to its pressurized position, rotor assembly 32 rises to its operational position of noncontact but close juxtaposition to volute's “knife-edge” 16 for maximally efficient operation without “knife-edge” impingement and resultant destruction of rotor assembly 32.

Thrust-versions for mechanical or air-bearings may be used such that the lateral rotors in the rotor assembly also make and maintain noncontact but close juxtaposition to the inner sides of the spiral volute, on the order of half of the interdiscsal-spacing for that rotor assembly. Such tight juxtapositioning of the rotor assembly to the inner volute sides helps prevent generated pressure losses from within the volute. Juxtapositioning less than half of the interdiscal-spacing helps even more so long as such positioning remains noncontact between disc-rotors and the inner sides of the volute.

Although the invention has been described in connection with the preferred embodiment, it is not intended to limit the invention's particular form set forth, but on the contrary, it is intended to cover such alterations, modifications, and equivalences that may be included in the spirit and scope of the invention as defined by the appended claims.

1. A method of manufacturing a rotor assembly for a bladeless pump, the method comprising:
providing an injection mold or stamping having a reference mark;
injection molding or stamping multiple rotors from the mold or stamp, the rotors having a reference mark thereon and spokes; and
assembling the rotors on an axle such that any balances eccentricities are minimized.

2. The method of claim 1, wherein the assembling step comprises rotating and entraining successive rotors with their reference marks on opposite sides of the axle and such that the spokes are aligned.

3. The method of claim 2, wherein the rotors have standoffs defining standoff radii and, during assembling, placing one rotor with respect to an adjacent rotor so as to keep spokes aligned.

4. The method of claim 3, wherein the placing aligns the standoff radii.

5. The method of claim 3, wherein the placing spaces angularly the standoff radii.

6. The method of claim 1, wherein the mold or stamping is adapted to produce rotors with perforations and wherein during the assembling step, one aligns the perforations and further including the step of introducing a rotor fusing agent through the aligned perforations.

7. The method of claim 1, wherein the mold or stamping creates rotors with dimples and wherein during the assembling step, the rotors with the dimples are placed on the axle such that no adjacent rotors have their dimples in an aligned position and wherein the spokes of all the rotors are aligned.

8. The method of claim 1, wherein the mold creates the rotor with solid stand-offs and wherein, during assembling, the rotors are entrained on the axle such that the stand-offs are radially aligned and wherein the spokes are aligned.

9. The method of claim 1, further including, following the assembling step, fusing the rotors to one another.

10. The method of claim 1, wherein the reference marks are used in the assembling step to determine rotor location on an axle with respect to adjacent rotors.

11. The method of claim 1, wherein the mold or stamping provides for a rotor with multiplicity of concentric standoffs and the standoffs lay in equiangular standoff radii.

12. The method of claim 1, wherein the rotors have standoffs and wherein the standoffs are equiangularly spaced with respect to such radii during the assembling step with spokes aligned.

13. The method of claim 1, wherein the spokes include pins and indentations.

14. A pump having:
a rotor assembly having multiple rotors, each rotor with an outer periphery and an axle;
a rotor assembly housing;
wherein the rotors include a spoke section and wherein the spokes of the rotor assembly are aligned; and
wherein the rotors include a reference mark, and wherein the reference mark of adjacent rotors on the rotor assembly are angularly spaced apart; and
a spiral volute having a knife edge wherein the rotor assembly is mounted close to the knife edge.

15. The pump of claim 14, further including bearing standards, supporting a multiplicity of bearings and further including a vibration isolator.

16. The pump of claim 14, wherein the rotors are thicker near the outer periphery.

17. The pump of claim 14, wherein the rotors have runner portions which have standoffs.

18. The pump of claim 17, wherein the standoffs are fused.

19. The pump of claim 14, wherein the rotors comprise an integral, one-piece spoke assembly/runners portion with the runner portion being thinner than the spoke assembly.

20. The pump of claim 14, wherein the axle of the rotor assembly is polygonal.

21. The pump of claim 14, wherein the rotors are fused to the axle.

22. The pump of claim 14, wherein the rotor assembly is pre-balanced.
